(19) United States
(12) Patent Application Publication
(10) Pub. No.: US 2008/0130465 A1
(43) Pub. Date: Jun. 5, 2008

(54) Objective Optical System and Optical Information Recording/Reproducing Device Having the Same

(75) Inventors: Daisuke KOREEDA, Saitama (JP); Shuichi TAKEUCHI, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/949,175

(22) Filed: Dec. 3, 2007

(30) Foreign Application Priority Data
Dec. 4, 2006 (JP) 2006-327188
Feb. 21, 2007 (JP) 2007-041316

(51) Int. Cl. G11B 7/135

(52) U.S. Cl. 369/112.03; 369/112.23

(57) ABSTRACT

There is provided an objective optical system which includes a chromatic aberration correction element having a negative power first lens and a positive power second lens, materials of the first and lenses being different from each other, the first and second lenses being cemented together via a cementing surface to correct a longitudinal chromatic aberration, at least one phase shift surface configured to give a predetermined optical path length difference to a first light beam, and an objective lens. Each of the chromatic aberration correction element and the at least one phase shift surface is located along an optical path common to the first and second light beams. The chromatic aberration correction element is located on a light source side with respect to the objective lens.

### BACKGROUND OF THE INVENTION

The present invention relates to an objective optical system which is installed in a device employing multiple types of light beams having different wavelengths, such as an optical information recording/reproducing device for recording information to and/or reproducing information from multiple types of optical discs differing in recording density.

There exist various standards of optical discs (CD, DVD, etc.) differing in recording density, protective layer thickness, etc. Meanwhile, new-standard optical discs (HD DVD (High-Definition DVD), BD (Blu-ray Disc), etc.), having still higher recording density than DVD, are being brought into practical use in recent years to realize still higher information storage capacity. The protective layer thickness of such a new-standard optical disc is substantially equal to or less than that of DVD. In consideration of user convenience with such optical discs according to multiple standards, the optical information recording/reproducing devices (more specifically, objective lenses installed in the devices) of recent years are required to have compatibility with the above three types of optical discs. Incidentally, in this specification, the “optical information recording/reproducing devices” include devices for both information reproducing and information recording, devices exclusively for information reproducing, and devices exclusively for information recording. The above “compatibility” means that the optical information recording/reproducing device ensures the information reproducing and/or information recording with no need of component replacement even when the optical disc being used is switched.

In order to provide an optical information recording/reproducing device with the compatibility with optical discs of multiple standards, the device has to be configured to be capable of forming a beam spot suitable for a particular recording density of a new disc (in the switching of the optical disc to the new disc of a different standard) by changing a NA (Numerical Aperture) of the light beam employed for the information reproducing/registering, while also correcting spherical aberration which varies depending on the protective layer thickness. Since the diameter of the beam spot can generally be made smaller as the wavelength of the beam gets shorter, multiple laser beams having different wavelengths are selectively used by the optical information recording/reproducing device depending on the recording density of the optical disc being used. For example, for DVDs, a laser beam with a wavelength of approximately 660 nm (shorter than approximately 790 nm for CDs) is used. For the aforementioned new-standard optical discs, a laser beam with a wavelength still shorter than that for DVDs (e.g. so-called “blue laser” around 408 nm) is used in order to deal with the extra-high recording density.

When such a new-standard optical disc is used, the laser beam need to be converged on a record surface of the optical disc so that a smaller beam spot can be formed on the record surface because the optical disc has the further higher recording density. For this reason, aberrations have to be suitably corrected.

One of the aberrations to be corrected is a longitudinal chromatic aberration. The longitudinal chromatic aberration is caused when the wavelength of the laser beam from the light source varies slightly. Configurations for correcting the longitudinal chromatic aberration are disclosed in Japanese Patent Provisional Publication Nos. 2001-337269 (hereafter, referred to as JP2001-337269A), 2002-333575 (hereafter, referred to as JP2002-333575A), and 2006-65902 (hereafter, referred to as JP2006-65902A).

The JP2001-337269A discloses a device which executes the information reproducing and/or information recording for a new-standard optical disc with a so-called blue laser. In the device disclosed in JP2001-337269A, an optical element formed by cementing two positive and negative lenses together is located on the front side of an objective lens so that the longitudinal chromatic aberration can be corrected.

However, the device disclosed in JP2001-337269A is dedicated for information reproducing and/or information recording for a new-standard optical disc. Therefore, there is a case where the longitudinal chromatic aberration is not corrected appropriately for optical discs other than the new-standard optical disc.

The JP2002-333575A also discloses a device which executes the information reproducing and/or information recording for a new-standard optical disc with a so-called blue laser. In the device disclosed in JP2002-333575A, one of lens surfaces forming a condensing optical system is provided with a diffracting structure so that the longitudinal chromatic aberration can be corrected.

In general, a diffracting structure is uniquely defined by a wavelength and a diffraction order of light used for information reproducing and/or information recording. Therefore, by considering the fact that, similarly to the device disclosed in JP2001-337269A, the device in JP2002-333575A is configured exclusively for information reproducing and/or information recording for a new-standard optical disc, it is understood that the diffracting structure is configured to suitably correct the longitudinal chromatic aberration caused when a so-called blue laser is used. If a configuration of the device disclosed in JP2002-333575A is applied to a design of a device having the compatibility with multiple types of optical discs, appropriate control of the amount of the longitudinal chromatic aberration with the diffracting structure is impossible for the light beams waving wavelengths other than the wavelength of the so-called blue laser.

JP2006-65902A discloses a device having the compatibility with the three types of optical discs including a new-standard optical disc, DVD and CD. In the device disclosed in JP2006-65902A, a chromatic aberration correction element is located on an optical path common to the laser beams used for the three types of optical discs, and another chromatic aberration correction element is located on an optical path for the laser beam used for information reproducing and/or information recording for the so-called blue laser. That is, the device disclosed in JP2006-65902A is configured to correct, through the two types of chromatic aberration correction elements, the chromatic aberration caused when the new-standard optical disc is used and to correct, through one chromatic aberration correction element, the chromatic aberration caused when DVD or CD is used.

However, the configuration of the device disclosed in JP2006-65902A needs to have more than one optical element for correcting the chromatic aberration. This requirement increases the number of optical elements in an optical information recording/reproducing device and becomes factors preventing the cost reduction or the downsizing of the optical information recording/reproducing device.

### SUMMARY OF THE INVENTION

The present invention is advantageous in that it provides an optical system which has compatibility with multiple types of optical discs and which is capable of effectively correcting a longitudinal chromatic aberration caused when an optical disc having a high recording density is used, while realizing a simple configuration, and an optical information recording/reproducing device for such an optical system.

According to an aspect of the invention, there is provided an objective optical system used for an optical information recording/reproducing device for recording information to and/or reproducing information from at least two types of optical discs including a first optical disc and a second optical disc having a recording density lower than that of the first optical disc, by selectively using one of two types light beams including a first light beam having a first wavelength λ₁ and a second light beam having a second wavelength λ₂ larger than the first wavelength λ₁. The objective optical system includes a chromatic aberration correction element including a first lens having a negative power and a second lens having a positive power, materials of the first lens and the second lens being different from each other, the first lens and the second lens being cemented together via a cementing surface to correct a longitudinal chromatic aberration, at least one phase shift surface configured to have a plurality of annular refractive surface zones concentrically formed about a reference axis of the at least one phase shift surface and to have a step formed between adjacent ones of the plurality of annular refractive surface zones to give a predetermined optical path length difference to the first light beam, and an objective lens.

In this configuration, each of the chromatic aberration correction element and the at least one phase shift surface is located along an optical path common to the first and second light beams. The chromatic aberration correction element is located on a light source side with respect to the objective lens.

With this configuration, it becomes possible to achieve the compatibility with at least two types of optical discs while correcting, for each of the at least two types of optical discs, the relative longitudinal chromatic aberration caused when the information recording/reproducing.

In at least one aspect, the predetermined optical path length difference given by the step of the at least one phase shift surface to the first light beam is approximately equal to 2λ₁; and the objective optical system satisfies a condition:

$$0.44 < \frac{\{ ( nB 1 - nB 2 ) - ( nR 1 - nR 2 ) \} \{ ( f 1 / R ) + 0.008 N \}}{nB 3 - nR 3} < 2.00 \qquad ( 1 )$$

where N represents the number of annular zones, nB1 represents a refractive index of the first lens at the first wavelength λ₁, nB2 represents a refractive index of the second lens at the first wavelength λ₁, nR1 represents a refractive index of the first lens at the second wavelength λ₂, nR2 represents a refractive index of the second lens at second wavelength λ₂, R represents a radius of curvature of the cementing surface of the chromatic aberration correction element, and f1 represents a total focal length at the first wavelength λ₁, nB3 represents a refractive index of the objective lens at the first wavelength λ₁, and nR3 represents the refractive index of the objective lens at second wavelength λ₂.

In at least one aspect, the objective optical system satisfies a condition:

$$0.74 < \frac{\begin{matrix}\{ ( nB 1 - nB 2 ) - ( nR 1 - nR 2 ) \} \\ \{ ( f 1 / R ) + 0.008 N \}\end{matrix}}{nB 3 - nR 3} < 1.70 . \qquad ( 2 )$$

In at least one aspect, the objective optical system satisfies a condition:

$$0.95 < \frac{\begin{matrix}\{ ( nB 1 - nB 2 ) - ( nR 1 - nR 2 ) \} \\ \{ ( f 1 / R ) + 0.014 N \}\end{matrix}}{nB 3 - nR 3} < 2.19 . \qquad ( 3 )$$

In at least one aspect, the predetermined optical path length difference given by the step of the at least one phase shift surface to the first light beam is approximately equal to 3λ₁; and the objective optical system satisfies a condition:

$$0.43 < \frac{\begin{matrix}\{ ( nB 1 - nB 2 ) - ( nR 1 - nR 2 ) \} \\ \{ ( f 1 / R ) + 0.008 N \}\end{matrix}}{nB 3 - nR 3} < 1.38 . \qquad ( 11 )$$

In at least one aspect, the objective optical system satisfies a condition:

$$0.68 < \frac{\begin{matrix}\{ ( nB 1 - nB 2 ) - ( nR 1 - nR 2 ) \} \\ \{ ( f 1 / R ) + 0.008 N \}\end{matrix}}{nB 3 - nR 3} < 1.13 . \qquad ( 12 )$$

In at least one aspect, the objective optical system satisfies a condition:

$$0.80 < \frac{\begin{matrix}\{ ( nB 1 - nB 2 ) - ( nR 1 - nR 2 ) \} \\ \{ ( f 1 / R ) + 0.014 N \}\end{matrix}}{nB 3 - nR 3} < 1.13 . \qquad ( 13 )$$

According to another aspect of the invention, there is provided an objective optical system used for an optical information recording/reproducing device for recording information to and/or reproducing information from at least two types of optical discs including a first optical disc and a second optical disc having a recording density lower than that of the first optical disc, by selectively using one of two types light beams including a first light beam having a first wavelength and a second light beam having a second wavelength larger than the first wavelength. The objective optical system includes a chromatic aberration correction element including a first lens having a negative power and a second lens having a positive power, materials of the first lens and the second lens being different from each other, the first lens and the second lens being cemented together via a cementing surface to correct a longitudinal chromatic aberration, at least one diffracting surface, and an objective lens.

In this configuration, the at least one diffracting surface is represented by an optical path length difference function φi(h) (where i is an integer):

φ(h)=(Pᵢ₂h²+Pᵢ₄h⁴+Pᵢ₆h⁶+Pᵢ₈h⁸+Pᵢ₁₀h¹⁰+Pᵢ₁₂h¹²)mᵢλ

where Pᵢ₂, Pᵢ₄, Pᵢ₆ . . . represents 2-th, 4-th, 6-th . . . coefficients, mᵢ represents a diffraction order at which diffraction efficiency of an incident light beam incident on the at least one diffracting surface is maximized, and λ represents a design wavelength of the incident light beam. Each of the chromatic aberration correction element and the at least one diffracting surface is located along an optical path common to the first and second light beams. The chromatic aberration correction element is located on a light source side with respect to the objective lens.

With this configuration, it becomes possible to achieve the compatibility with at least two types of optical discs while correcting, for each of the at least two types of optical discs, the relative longitudinal chromatic aberration caused when the information recording/reproducing.

In at least one aspect, the at least one diffracting surface is configured such that a diffraction order at which the diffraction efficiency for the first light beam is maximized is a second order, and the objective optical system satisfies a condition:

$$0.55 < \frac{\begin{matrix}\{ ( nB 1 - nB 2 ) - ( nR 1 - nR 2 ) \} \\ \{ ( f 1 / R ) - 0.03 {P}_{12} \}\end{matrix}}{nB 3 - nR 3} < 1.65 . \qquad ( 4 )$$

In at least one aspect, the objective optical system satisfies a condition:

$$0.85 < \frac{\begin{matrix}\{ ( nB 1 - nB 2 ) - ( nR 1 - nR 2 ) \} \\ \{ ( f 1 / R ) - 0.03 {P}_{12} \}\end{matrix}}{nB 3 - nR 3} < 1.40 . \qquad ( 5 )$$

In at least one aspect, the objective optical system satisfies a condition:

$$1.10 < \frac{\begin{matrix}\{ ( nB 1 - nB 2 ) - ( nR 1 - nR 2 ) \} \\ \{ ( f 1 / R ) - 0.06 {P}_{12} \}\end{matrix}}{nB 3 - nR 3} < 1.80 . \qquad ( 6 )$$

In at least one aspect, the at least one diffracting surface is configured such that a diffraction order at which the diffraction efficiency for the first light beam is maximized is a third order, and the objective optical system satisfies a condition:

$$0.25 < \frac{\begin{matrix}\{ ( nB 1 - nB 2 ) - ( nR 1 - nR 2 ) \} \\ \{ ( f 1 / R ) - 0.03 {P}_{12} \}\end{matrix}}{nB 3 - nR 3} < 1.19 . \qquad ( 14 )$$

In at least one aspect, the objective optical system satisfies a condition:

$$0.48 < \frac{\begin{matrix}\{ ( nB 1 - nB 2 ) - ( nR 1 - nR 2 ) \} \\ \{ ( f 1 / R ) - 0.03 {P}_{12} \}\end{matrix}}{nB 3 - nR 3} < 0.98 . \qquad ( 15 )$$

In at least one aspect, the objective optical system satisfies a condition:

$$0.45 < \frac{\begin{matrix}\{ ( nB 1 - nB 2 ) - ( nR 1 - nR 2 ) \} \\ \{ ( f 1 / R ) - 0.06 {P}_{12} \}\end{matrix}}{nB 3 - nR 3} < 0.86 . \qquad ( 16 )$$

In the above described aspects of the invention, the objective optical system may include an optical element on which the at least one diffracting surface is formed.

In the above described aspects of the invention, the at east one diffracting surface may be formed on at least one of surfaces of the objective lens.

In the above described aspects of the invention, the first lens of the chromatic aberration correction element may include a planoconcave lens, the second lens of the chromatic aberration correction element may include a planoconvex lens, and the chromatic aberration correction element may be configured such that curved surfaces of the first lens and the second lens form the cementing surface.

According to another aspect of the invention, there is provided an optical information recording/reproducing device for recording information to and/or reproducing information from three types of optical discs including a first optical disc having a highest recording density, a second optical disc having a second highest recording density and a third optical disc having a lowest recording density, by selectively using one of three types of light beams including first, second and third light beams. When wavelengths of the first to third light beams are respectively represented by λ₁ (mm), λ₂ (nm) and λ₃ (nm), λ₁<λ₂<λ₃ are satisfied. When a thickness of a protective layer of the first optical disc requiring use of the first light beam is represented by t1 (mm), a thickness of a protective layer of the second optical disc requiring use of the second light beam is represented by t2 (mm), and a thickness of a protective layer of the third optical disc requiring use of the third light beam is represented by t3 (mm), t1≈0.6 (mm), t2≈0.6 (mm) and t3≈1.2 (mm) are satisfied. When a numerical aperture necessary for recording information to or reproducing information from the first optical discs is represented by NA1, a numerical aperture necessary for recording information to or reproducing information from the second optical discs is represented by NA2, and a numerical aperture necessary for recording information to or reproducing information from the third optical discs is represented by NA3, a relationship NA1>NA3 and NA2>NA3 are satisfied.

In this configuration, The optical information recording/reproducing device includes three light sources respectively emitting the first, second and third light beams, and an objective optical system. In this configuration, the objective optical system includes a chromatic aberration correction element including a first lens having a negative power and a second lens having a positive power, materials of the first lens and the second lens being different from each other, the first lens and the second lens being cemented together via a cementing surface to correct a longitudinal chromatic aberration, at least one phase shift surface configured to have a plurality of annular refractive surface zones concentrically formed about a reference axis of the at least one phase shift surface and to have at least one type of step formed between adjacent ones of the plurality of annular refractive surface zones to give at least one type of predetermined optical path length difference to the first light beam, and an objective lens. Each of the chromatic aberration correction element and the at least one phase shift surface is located along an optical path common to the first and second light beams. The chromatic aberration correction element is located on a light source side with respect to the objective lens.

Such a configuration enables the optical information recording/reproducing device to correct the longitudinal chromatic aberration and the spherical aberration by letting a substantially collimated beam enter the objective lens when the first and second optical discs having higher recording densities of the three types of optical discs are used. When the third optical disc having the lowest recording density is used, the optical information recording/reproducing device is able to correct the longitudinal chromatic aberration and the spherical aberration by letting a diverging beam enter the objective lens.

In at least one aspect, the predetermined optical path length difference given by the step of the at least one phase shift surface to the first light beam is approximately equal to 2λ₁; and the objective optical system satisfies the condition (1).

In at least one aspect, the objective optical system satisfies the condition (2).

In at least one aspect, the objective optical system satisfies the condition (3).

In at least one aspect, the predetermined optical path length difference given by the step of the at least one phase shift surface to the first light beam is approximately equal to 3λ₁; and the objective optical system satisfies the condition (11).

In at least one aspect, the objective optical system satisfies the condition (12).

In at least one aspect, the objective optical system satisfies the condition (13).

In at least one aspect, the at least one phase shift surface is configured to have two types of steps. Each of the first, second and third light beams is incident on the objective optical system as a substantially collimated beam.

According to another aspect of the invention, there is provided an optical information recording/reproducing device for recording information to and/or reproducing information from three types of optical discs including a first optical disc having a highest recording density, a second optical disc having a second highest recording density and a third optical disc having a lowest recording density, by selectively using one of three types of light beams including first, second and third light beams. When wavelengths of the first to third light beams are respectively represented by λ₁ (nm), λ₂ (nm) and λ₃ (nm), λ₁<λ₂<λ₃ are satisfied. When a thickness of a protective layer of the first optical disc requiring use of the first light beam is represented by t1 (mm), a thickness of a protective layer of the second optical disc requiring use of the second light beam is represented by t2 (mm), and a thickness of a protective layer of the third optical disc requiring use of the third light beam is represented by t3 (mm), t1≈0.6 (mm), t2≈0.6 (mm) and t3≈1.2 (mm) are satisfied. When a numerical aperture necessary for recording information to or reproducing information from the first optical discs is represented by NA1, a numerical aperture necessary for recording information to or reproducing information from the second optical discs is represented by NA2, and a numerical aperture necessary for recording information to or reproducing information from the third optical discs is represented by NA3, a relationship NA1>NA3 and NA2>NA3 are satisfied.

In this configuration, the optical information recording/reproducing device includes three light sources respectively emitting the first, second and third light beams, and an objective optical system. The objective optical system includes a chromatic aberration correction element including a first lens having a negative power and a second lens having a positive power, materials of the first lens and the second lens being different from each other, the first lens and the second lens being cemented together via a cementing surface to correct a longitudinal chromatic aberration, at least one diffracting surface; and an objective lens. The at least one diffracting surface is represented by at least one optical path length difference function φi(h). Each of the chromatic aberration correction element and the at least one diffracting surface is located along an optical path common to the first and second light beams. The chromatic aberration correction element is located on a light source side with respect to the objective lens.

Such a configuration enables the optical information recording/reproducing device to correct the longitudinal chromatic aberration and the spherical aberration by letting a substantially collimated beam enter the objective lens when the first and second optical discs having higher recording densities of the three types of optical discs are used. When the third optical disc having the lowest recording density is used, the optical information recording/reproducing device is able to correct the longitudinal chromatic aberration and the spherical aberration by letting a diverging beam enter the objective lens.

In at least one aspect, the at least one diffracting surface is configured such that a diffraction order at which the diffraction efficiency for the first light beam is maximized is a second order, and the objective optical system satisfies the condition (4).

In at least one aspect, the objective optical system satisfies the condition (5).

In at least one aspect, the objective optical system satisfies the condition (6).

In at least one aspect, the at least one diffracting surface is configured such that a diffraction order at which the diffraction efficiency for the first light beam is maximized is a third order, and the objective optical system satisfies the condition (14).

In at least one aspect, the objective optical system satisfies the condition (15).

In at least one aspect, the objective optical system satisfies the condition (16).

In at least one aspect, the at least one diffracting surface is represented by two optical path length difference functions. In this case, each of the first, second and third light beams is incident on the objective lens as a collimated beam.

In at least one aspect, the predetermined optical path length difference given by the step of the at least one phase shift surface to the first light beam is approximately equal to 2λ₁, the optical information recording/reproducing device may satisfy conditions:

−0.02<f1×M1<0.02 (7),

−0.02<f2×M2<0.02 (8), and

−0.28<f3×M3<−0.18 (9)

where M1 represents a total magnification at the first wavelength λ₁, f2 represents a total focal length at the second wavelength 2, and M2 represents a total magnification at the second wavelength λ₂, f3 represents a total focal length at the third wavelength λ₃, and a M3 represents a total magnification at the third wavelength λ₃.

In at least one aspect, the predetermined optical path length difference given by the step of the at least one phase shift surface to the first light beam is approximately equal to 3λ₁, the optical information recording/reproducing device may satisfy conditions:

−0.02<f1×M1<0.02 (7),

−0.02<f2×M2<0.02 (8), and

−0.19<f3×M3<−0.05 (17)

In at least one aspect, the at least one diffracting surface is configured such that a diffraction order at which the diffraction efficiency for the first light beam is maximized is a second order, the optical information recording/reproducing device may satisfy conditions (7), (8), (9).

In at least one aspect, the at least one diffracting surface is configured such that a diffraction order at which the diffraction efficiency for the first light beam is maximized is a third order, the optical information recording/reproducing device may satisfy conditions (7), (8), (17).

In the above mentioned aspects of the invention, the chromatic aberration correction element may satisfy a condition:

$$- 3.30 < \frac{nB 1 - nB 2}{nR 1 - nR 2} < - 0.30 . \qquad ( 10 )$$

### BRIEF DESCRIPTION OF THE ACCOMPANYING DRAWINGS

FIG. 1 is an optical block diagram illustrating a general configuration of an optical information recording/reproducing device having an objective optical system according to a first embodiment of the invention.

FIG. 2A is a block diagram of an optical system defined in the optical information recording/reproducing device when an optical disc D1 having the highest recording density is used.

FIG. 2B is a block diagram of an optical system defined in the optical information recording/reproducing device when an optical disc D2 having the second highest recording density is used.

FIG. 2C is a block diagram of an optical system defined in the optical information recording/reproducing device when an optical disc D3 having the lowest recording density is used.

FIG. 3A is an example of a block diagram of the objective optical system in which an aperture stop is provided to restrict a beam diameter of a third laser beam.

FIG. 3B is a front view of the aperture stop.

FIG. 4A is a graph illustrating the spherical aberration caused when the first laser beam is used in the optical information recording/reproducing device according to a first example.

FIG. 4B is a graph illustrating the spherical aberration caused when the second laser beam is used in the optical information recording/reproducing device according to the first example.

FIG. 4C is a graph illustrating the spherical aberration caused when the third laser beam is used in the optical information recording/reproducing device according to the first example.

FIG. 5A is a graph illustrating the spherical aberration caused when the first laser beam is used in the optical information recording/reproducing device according to a comparative example.

FIG. 5B is a graph illustrating the spherical aberration caused when the second laser beam is used in the optical information recording/reproducing device according to the comparative example.

FIG. 5C is a graph illustrating the spherical aberration caused when the third laser beam is used in the optical information recording/reproducing device according to the comparative example.

FIG. 6A is a graph illustrating the spherical aberration caused when the first laser beam is used in the optical information recording/reproducing device according to a second example.

FIG. 6B is a graph illustrating the spherical aberration caused when the second laser beam is used in the optical information recording/reproducing device according to the second example.

FIG. 6C is a graph illustrating the spherical aberration caused when the third laser beam is used in the optical information recording/reproducing device according to the second example.

FIG. 7A is a graph illustrating the spherical aberration caused when the first laser beam is used in the optical information recording/reproducing device according to a third example.

FIG. 7B is a graph illustrating the spherical aberration caused when the second laser beam is used in the optical information recording/reproducing device according to the third example.

FIG. 7C is a graph illustrating the spherical aberration caused when the third laser beam is used in the optical information recording/reproducing device according to the third example.

FIG. 8A is a graph illustrating the spherical aberration caused when the first laser beam is used in the optical information recording/reproducing device according to a fourth example.

FIG. 8B is a graph illustrating the spherical aberration caused when the second laser beam is used in the optical information recording/reproducing device according to the fourth example.

FIG. 8C is a graph illustrating the spherical aberration caused when the third laser beam is used in the optical information recording/reproducing device according to the fourth example.

FIG. 9A is a graph illustrating the spherical aberration caused when the first laser beam is used in the optical information recording/reproducing device according to a comparative example.

FIG. 9B is a graph illustrating the spherical aberration caused when the second laser beam is used in the optical information recording/reproducing device according to the comparative example.

FIG. 9C is a graph illustrating the spherical aberration caused when the third laser beam is used in the optical information recording/reproducing device according to the comparative example.

FIG. 10A is a graph illustrating the spherical aberration caused when the first laser beam is used in the optical information recording/reproducing device according to a fifth example.

FIG. 10B is a graph illustrating the spherical aberration caused when the second laser beam is used in the optical information recording/reproducing device according to the fifth example.

FIG. 10C is a graph illustrating the spherical aberration caused when the third laser beam is used in the optical information recording/reproducing device according to the fifth example.

FIG. 11A is a graph illustrating the spherical aberration caused when the first laser beam is used in the optical information recording/reproducing device according to a sixth example.

FIG. 11B is a graph illustrating the spherical aberration caused when the second laser beam is used in the optical information recording/reproducing device according to the sixth example.

FIG. 11C is a graph illustrating the spherical aberration caused when the third laser beam is used in the optical information recording/reproducing device according to the sixth example.

FIG. 12A is a block diagram of an optical system defined in the optical information recording/reproducing device according to the seventh example when an optical disc D1 is used.

FIG. 12B is a block diagram of an optical system defined in the optical information recording/reproducing device according to the seventh example when an optical disc D2 is used.

FIG. 12C is a block diagram of an optical system defined in the optical information recording/reproducing device according to the seventh example when an optical disc D3 having the lowest recording density is used.

FIG. 13A is a graph illustrating the spherical aberration caused when the first laser beam is used in the optical information recording/reproducing device according to a seventh example.

FIG. 13B is a graph illustrating the spherical aberration caused when the second laser beam is used in the optical information recording/reproducing device according to the seventh example.

FIG. 13C is a graph illustrating the spherical aberration caused when the third laser beam is used in the optical information recording/reproducing device according to the seventh example.

FIG. 14 is an example of a configuration of the optical information recording/reproducing device in which a phase shift surface is formed on an optical element other than an objective lens.

FIG. 15 is a cross section of the objective lens illustrating a conceptual diagram of the phase shift structure formed on a surface of the objective lens.

### DETAILED DESCRIPTION OF THE EMBODIMENTS

Hereinafter, an embodiment according to the invention is described with reference to the accompanying drawings. An objective optical system according to the embodiments, which is installed in an optical information recording/reproducing device, has the compatibility with three types of optical discs according to different standards (protective layer thickness, recording density, etc.).

In the following explanation, an optical disc of a type (one of the three types) having the highest recording density (e.g. a new-standard optical disc such as HD DVD or BD) will be referred to as a “optical disc D1”, an optical disc of a type having a relatively low recording density compared to the optical disc D1 (DVD, DVD-R, etc.) will be referred to as a “optical disc D2”, and an optical disc of a type having the lowest recording density (CD, CD-R, etc.) will be referred to as a “optical disc D3” for convenience of explanation.

If the protective layer thicknesses of the optical discs D1-D3 are defined as t1, t2, t3, respectively, the protective layer thicknesses are defined as follows.

t1≈0.6 mm

t2≈0.6 mm

t3≈1.2 mm

In order to carry out the information reproducing/recording on each of the optical discs D1-D3, the NA (Numerical Aperture) required for the information reproducing/recording has to be varied properly so that a beam spot suitable for the particular recording density of each disc can be formed. When the optimum design numerical apertures required for the information reproducing/recording on the three types of optical discs D1, D2 and D3 are defined as NA1, NA2 and NA3, respectively, the numerical apertures (NA1, NA2, NA3) satisfy the following relationships:

(NA1>NA3) and (NA2>NA3)

Specifically, for the information recording/reproducing on the optical disc D1, D2 (having high recording density), a relatively large NA is required since a relatively small spot has to be formed. On the other hand, for the information recording/reproducing on the optical disc D3 (having the lowest recording density), the required NA is relatively small. Incidentally, each optical disc is set on a turntable (not shown) and rotated at high speed when the information recording/reproducing is carried out.

In cases where three types of optical discs D1-D3 (having different recording densities) are used as above, multiple laser beams having different wavelengths are selectively used by the optical information recording/reproducing device so that a beam spot suitable for each recording density can be formed on the record surface of the optical disc being used. In the following, a wavelength of the laser beam defined for obtaining a suitable beam spot corresponding to the recording density of each disc is referred to as a design wavelength.

Specifically, for the information recording/reproducing on the optical disc D1, a “first laser beam” having the shortest wavelength (first design wavelength) is emitted from a light source so as to form the smallest beam spot on the record surface of the optical disc D1. On the other hand, for the information recording/reproducing on the optical disc D3, a “third laser beam” having the longest wavelength (third design wavelength) is emitted from a light source so as to form the largest beam spot on the record surface of the optical disc D3. For the information recording/reproducing on the optical disc D2, a “second laser beam” having a wavelength longer than that of the first laser beam and shorter than that of the third laser beam (second design wavelength) is emitted from a light source so as to form a relatively small beam spot on the record surface of the optical disc D2.

### First Embodiment

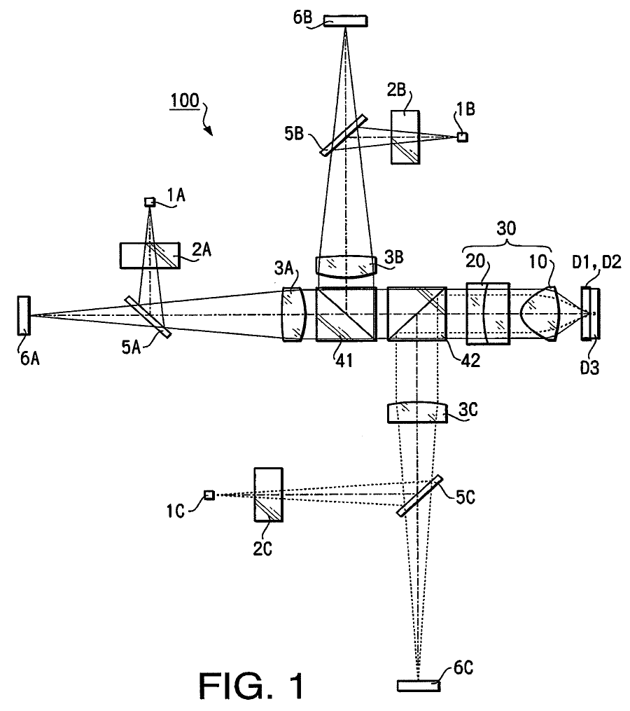

FIG. 1 is an optical block diagram illustrating a general configuration of an optical information recording/reproducing device 100 having an objective optical system 30 according to a first embodiment of the invention. The optical information recording/reproducing device 100 includes a light source 1A which emits the first laser beam, a light source 1B which emits the second laser beam, a light source 1C which emits the third laser beam, diffraction gratings 2A, 2B and 2C, coupling lenses 3A, 3B and 3C, beam splitters 41 and 42, half mirrors 5A, 5B and 5C, and photoreceptors 6A, 6B and 6C, and the objective optical system 30. The objective optical system 30 includes a chromatic aberration correction element 20 and an objective lens 10 which are located, on an optical path, in this order from a light source side.

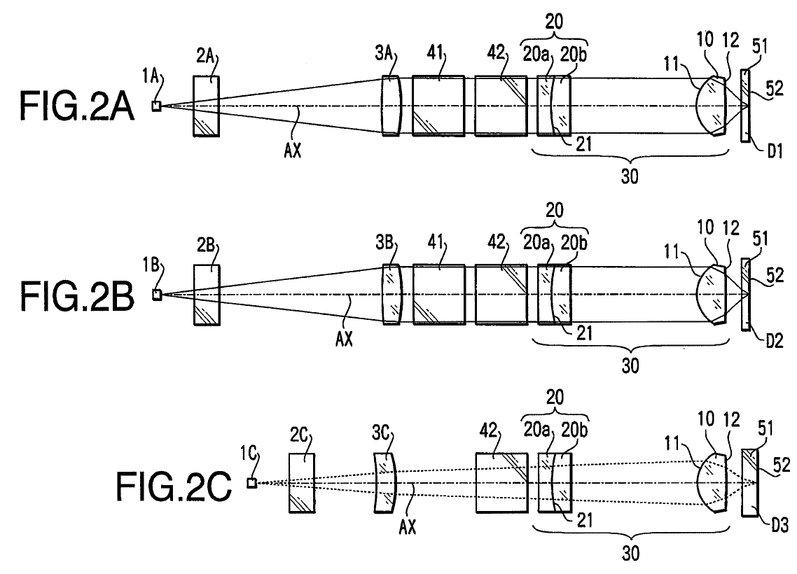

FIG. 2A is a block diagram of an optical system defined in the optical information recording/reproducing device 100 when the optical disc D1 is used. FIG. 2B is a block diagram of an optical system defined in the optical information recording/reproducing device 100 when the optical disc D2 is used. FIG. 2C is a block diagram of an optical system defined in the optical information recording/reproducing device 100 when the optical disc D3 is used. In each of FIGS. 2A-2C, a reference axis AX of the optical information recording/reproducing device 100 is represented by a chain line. In a state shown in each of FIGS. 2A-2C, an optical axis of the objective optical system 30 coincides with the reference axis AX; however, there is a case where the optical axis of the objective optical system 30 or an optical axis of the objective lens 10 shifts from the reference axis AX, for example, for a tracking operation.

Incidentally, since the optical information recording/reproducing device 100 has to support various NAs required for the information recording/reproducing on various optical discs, an aperture restricting element for specifying the beam diameter of the third laser beam may also be placed on an optical path of the third laser beam.

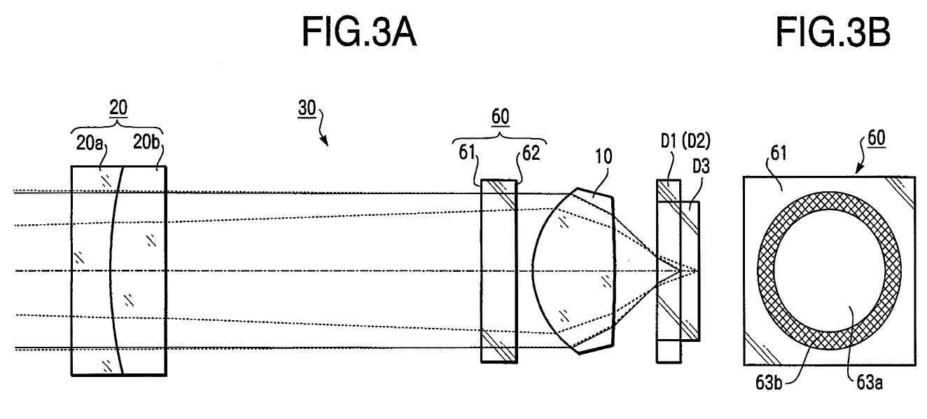

FIG. 3A is an example of a block diagram of the objective optical system 30 in which an aperture stop 60 is provided to restrict the beam diameter of the third laser beam. The aperture stop 60 has a first surface 61 and a second surface 62 located in this order from the light source side. FIG. 3B is a front view of the aperture stop 60 viewed from the side of the first surface 61. When the aperture stop 60 is viewed from the side of the second surface 62, the same structural feature as that shown in FIG. 3B can be observed. As shown in FIG. 3B, the first surface 61 of the aperture stop 60 is divided into two optically transparent areas 63a and 63b concentrically formed about an axis. The transparent area 63a has a property of allowing each of the first to third laser beams to transmit therethrough. The transparent area 63b has a property of allowing only the first and second laser beams to transmit therethrough and blocking the third laser beam. By locating the aperture stop 60 between the chromatic aberration correction element 20 and the objective lens 10, it is possible to restrict the beam diameter of the third laser beam to a required diameter. Therefore, it is possible to form a required beam spot on the optical disc D3.

As shown in each of FIGS. 2A-2C, each optical disc has a protective layer 51 and a record surface 52. Specifically, the record surface 52 is sandwiched between a label layer (not shown) and the protective layer 51.

As shown in FIG. 1, the first to third laser beams emitted by the light sources 1A to 1C are respectively directed to a common optical path through the diffraction gratings 2A, 2B and 2C, the coupling lenses 3A, 3B and 3C and the beam splitters 41 and 42, and then enter the objective optical system 30. After passing through the objective optical system 30, each of the first to third laser beams respectively converges to the position close to the record surface of each of the optical discs D1-D3. The first to third laser beams reflected by the record surface 22 are detected by the photoreceptor units 6A, 6B and 6C, respectively, after passing through the half mirrors 5A to 5C.

Since the optical information recording/reproducing device 100 selectively uses the first to third laser beams for the optical discs D1-D3, the spherical aberration caused on the record surface of the optical disc being used changes depending on change of a refractive index of the objective lens 10 or the difference in thickness of the protective layer 51 between the optical discs D1-D3.

In order to provide the compatibility with the three types of optical discs D1-D3 for the optical information recording/reproducing device 100, it is required to suitably correct the spherical aberration for each of the three types of optical discs. There is a possibility that the wavelength of each laser beam slightly fluctuates due to various environmental conditions, such as temperature change. The fluctuation of the wavelength causes the longitudinal chromatic aberration. If the longitudinal chromatic aberration, for example, when mode-hops occur, a beam spot having the diameter suitable for the information recording/reproducing can not be formed on the record surface of each optical disc. For the reason, the optical information recording/reproducing device 100 needs to suitably correct the longitudinal chromatic aberration as well as the spherical aberration.

If an optical information recording/reproducing device having an optical system formed of a small number of lenses is designed to decrease the longitudinal chromatic aberration caused when the optical disc D1 is used to approximately zero, the longitudinal chromatic aberration caused when the optical disc D2 is used becomes an overcorrected condition. On the other hand, if an optical information recording/reproducing device having an optical system formed of a small number of lenses is designed to decrease the longitudinal chromatic aberration caused when the optical disc D2 is used to approximately zero, correction of the longitudinal chromatic aberration caused when the optical disc D1 is used becomes an under state. Considering such conditions, the objective optical system 30 according to the embodiment is configured as indicated below so that the longitudinal chromatic aberration can be suitably corrected for each optical disc while achieving the compatibility with the plurality of types of optical discs.

The objective lens 10 has a first surface 11 and a second surface 12 in this order from the light source side. As shown in FIGS. 2A-2C, the objective lens 10 is a single-element biconvex lens. Each of the first and second surfaces 11 and 12 of the objective lens 10 is an aspherical surface.

A configuration of an aspherical surface can be expressed by the following expression:

$$X ( h ) = \frac{{ch}^{2}}{1 + \sqrt{1 - ( 1 + K ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + …$$

where X(h) denotes a SAG amount of a coordinate point on the aspherical surface whose height (distance) from the optical axis is h (SAG amount: distance measured from a tangential plane contacting the aspherical surface on the optical axis), “C” denotes the curvature (1/r) of the aspherical surface on the optical axis, “K” denotes a cone constant, and A₄, A₆, A₈, A₁₀, A₁₂, . . . denote aspherical coefficients of the fourth order, sixth order, eighth order, tenth order, twelfth order, and so forth.

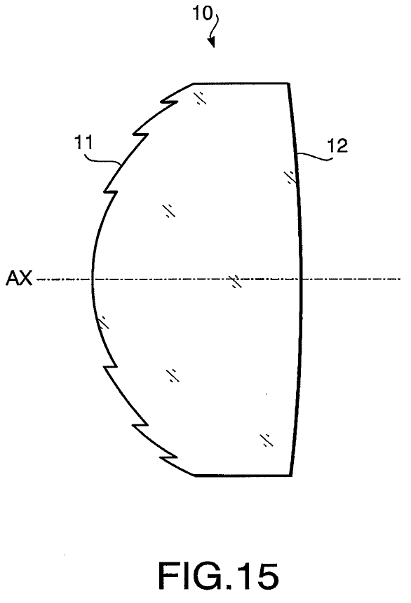

At least one of the first and second surfaces 11 and 12 of the objective lens 10 has a phase shift structure where the at least one surface is divided into a plurality of refractive surface zones (i.e., annular zones) concentrically formed about the reference axis AX (the optical axis of the objective lens 10) and a plurality of minute steps are formed between adjacent ones of the refractive surface zones. For example, the phase shift structure is formed on the first surface 11. FIG. 15 is a cross section of the objective lens 10 illustrating a conceptual diagram of the phase shift structure formed on the first surface 11.

A phase shift structure can be represented by an optical path length difference function φi(h) (where i is an integer). The optical path length difference function φi(h) represents the function of the objective lens 10 as a diffraction lens in a form of an additional optical path length at a height h from the optical axis. More specifically, the optical path length difference function φi(h) defines positions and heights of the minute steps in the phase shift structure. It should be noted that such a phase shift structure can be considered as a diffracting structure. The optical path length difference function φi(h) is represented by the following equation:

φ(h)=(Pᵢ₂h²+Pᵢ₄h⁴+Pᵢ₆h⁶+Pᵢ₈h⁸+Pᵢ₁₀h¹⁰+Pᵢ₁₂h¹²)mᵢλ

where Pᵢ₂, Pᵢ₄, Pᵢ₆, Pᵢ₈, Pᵢ₁₀, Pᵢ₁₂, represents 2nd coefficient, 4th coefficient, 6th coefficient, 8th coefficient, 10th coefficient, 12th coefficient, mᵢ represents the diffraction order at which the diffraction efficiency of the laser beam is maximized, and λ represents a design wavelength of the laser beam being used.

The phase shift structure formed on the objective lens 10 is configured to give a predetermined optical path length difference to the first laser beam so that the spherical aberration caused when each of the first and second laser beams is used can be suitably suppressed. More specifically, in the first embodiment, the phase shift structure formed on the objective lens 10 is configured to give an optical path length difference approximately equal to 2λ₁ (where λ₁ represents the wavelength (hereafter, frequently referred to as a first wavelength) of the first laser beam) to the first laser beam. In this case, the first design wavelength is assigned to λ of the optical path length difference function φi(h), and 2 is assigned to mᵢ of the optical path length difference function φi(h). By thus defining the values to be assigned to the optical path length difference function φi(h), it is possible to effectively suppress the spherical aberration caused when each of the first and second laser beams is incident on the objective lens 10 as a collimated beam.

The chromatic aberration correction element 20 functions as a longitudinal chromatic aberration correction element for appropriately controlling the amount of the longitudinal chromatic aberration caused when each of the first and second laser beams is used. The chromatic aberration correction element 20 is formed such that a positive lens and a negative lens of which materials are different from each other are cemented together. More specifically, the chromatic aberration correction element 20 is configured such that curved surfaces of a planoconcave lens 20a and a planoconvex lens 20b arranged in this order from the light source side are cemented together. In each of FIGS. 2A-2C, a cementing surface between the lenses 20a and 20b is assigned a numerical reference “21”.

In order to achieve the function of controlling the amount of the longitudinal chromatic aberration caused when each of the optical discs D1 and D2 is used, the chromatic aberration correction element 20 is configured considering the following conditions (1), (2), (4) and (5).

$$\begin{matrix}0.44 < \frac{\begin{matrix}\{ ( nB 1 - nB 2 ) - ( nR 1 - nR 2 ) \} \\ \{ ( f 1 / R ) + 0.008 N \}\end{matrix}}{nB 3 - nR 3} < 2.00 & ( 1 ) \\ 0.74 < \frac{\begin{matrix}\{ ( nB 1 - nB 2 ) - ( nR 1 - nR 2 ) \} \\ \{ ( f 1 / R ) + 0.008 N \}\end{matrix}}{nB 3 - nR 3} < 1.70 & ( 2 ) \\ 0.55 < \frac{\begin{matrix}\{ ( nB 1 - nB 2 ) - ( nR 1 - nR 2 ) \} \\ \{ ( f 1 / R ) - 0.03 {P}_{12} \}\end{matrix}}{nB 3 - nR 3} < 1.65 & ( 4 ) \\ 0.85 < \frac{\begin{matrix}\{ ( nB 1 - nB 2 ) - ( nR 1 - nR 2 ) \} \\ \{ ( f 1 / R ) - 0.03 {P}_{12} \}\end{matrix}}{nB 3 - nR 3} < 1.40 & ( 5 )\end{matrix}$$

In the above described conditions (and in the following conditions), N represents the number of annular zones, nB1 represents the refractive index of the planoconcave lens 20a at the first design wavelength, nB2 represents the refractive index of the planoconvex lens 20b at the first design wavelength, nR1 represents the refractive index of the planoconcave lens 20a at the second design wavelength, nR2 represents the refractive index of the planoconvex lens 20b at the second design wavelength, nB3 represents the refractive index of the objective lens 10 at the first design wavelength, nR3 represents the refractive index of the objective lens 10 at the second design wavelength, R represents the radius of curvature of the cementing surface 21 of the chromatic aberration correction element 20, and f1 represents a total focal length of the objective optical system 30 at the first design wavelength.

The conditions (1), (2), (4) and (5) are used to define, in regard to an axial power component of the surface 11 of the objective lens 10, the radius of curvature of the cementing surface 21 and materials of the planoconcave lens 20a and the planoconvex lens 20b forming the chromatic aberration correction element 20. By satisfying the condition (1) (or (4)), the longitudinal chromatic aberration caused when each of the optical discs D1 and D2 is used can be suitably corrected. By further satisfying the condition (2) (or (5)), the longitudinal chromatic aberration caused when each of the optical discs D1 and D2 is used can be corrected more suitably.

If the intermediate terms of the conditions (1) and (4) get lower than or equal to the respective lower limits of the conditions (1) and (4), the longitudinal chromatic aberration caused when the optical disc D1 is used becomes an undercorrected state. If the intermediate terms of the conditions (1) and (4) get larger than or equal to the respective upper limits of the conditions (1) and (4), the longitudinal chromatic aberration caused when the optical disc D2 is used becomes an overcorrected state.

In general, the higher the recording density of an optical disc becomes, the narrower the tolerance to aberrations becomes. In order to further lower the longitudinal chromatic aberration caused when the optical disc D1 is used, the objective optical system 30 may be configured to satisfy the following conditions (3) and (6).

$$\begin{matrix}0.95 < \frac{\begin{matrix}\{ ( nB 1 - nB 2 ) - ( nR 1 - nR 2 ) \} \\ \{ ( f 1 / R ) + 0.014 N \}\end{matrix}}{nB 3 - nR 3} < 2.19 & ( 3 ) \\ 1.10 < \frac{\begin{matrix}\{ ( nB 1 - nB 2 ) - ( nR 1 - nR 2 ) \} \\ \{ ( f 1 / R ) - 0.06 {P}_{12} \}\end{matrix}}{nB 3 - nR 3} < 1.80 & ( 6 )\end{matrix}$$

If the intermediate terms of the conditions (3) and (6) get lower than or equal to the respective lower limits of the conditions (3) and (6), the longitudinal chromatic aberration caused when the optical disc D1 is used becomes an undercorrected state. If the intermediate terms of the conditions (3) and (6) get larger than or equal to the respective upper limits of the conditions (3) and (6), the correction of the longitudinal chromatic aberration caused when the optical disc D1 is used becomes an overcorrected state.

The materials of the planoconcave lens 20a and the planoconvex lens 20b are selected so that the following condition (10) is satisfied.

$$- 3.30 < \frac{nB 1 - nB 2}{nR 1 - nR 2} < - 0.30 \qquad ( 10 )$$

The condition (10) relates to a ratio of a difference in refractive index defined at the first design wavelength between the planoconcave lens 20a and the planoconvex lens 20b and a difference in refractive index defined at the second design wavelength between the planoconcave lens 20a and the planoconvex lens 20b. By appropriately defining the ratio of the condition (10), it is possible to decrease the absolute value of the magnification of the objective lens 10 to a low level. If the intermediate term of the condition (10) gets lower than or equal to the lower limit of the condition (10), the absolute value of the magnification of the objective lens 10 defined when the optical disc D1 is used increases to an undesirable high level. If the intermediate term of the condition (10) gets larger than or equal to the upper limit of the condition (10), the absolute value of the magnification of the objective lens 10 defined when the optical disc D2 is used increases to an undesirable high level.

By thus configuring the objective optical system 30, it is possible to achieve the compatibility while suitably correcting the longitudinal chromatic aberration for each of the optical discs D1 and D2 having relatively high recording densities. By employing the objective optical system 30 configured as above and selectively using laser beams having different degrees of divergence depending on the type of the optical disc being used, the optical information recording/reproducing device 100 achieves the compatibility with the three types of optical discs D1-D3.

In a normal state, the objective optical system 30 is placed on the reference axis Ax of the optical information recording/reproducing device 100. However, there is a case where the objective optical system 30 or the objective lens 10 shifts from the reference axis AX for the tracking operation executed during the information recording/reproducing. In this case, if a diverging beam or a converging beam (a non-collimated beam) enters the objective optical system 30 or the objective lens 10, off-axis aberrations such as a coma and astigmatism may occur, although no off-axis aberration occurs when a collimated beam enters the objective optical system 30 or the objective lens 10. As described above, the larger the NA required for execution of the information recording/reproducing becomes, the narrower the tolerance to aberrations becomes. Therefore, when the optical disc requiring the high NA for execution of the information recording/reproducing is used, it is desirable that a collimated beam enters the objective optical system 30 to suppress the aberrations caused by off-axis light particularly when the objective optical system 30 shifts from the reference axis for the tracking operation.

For example, the optical information recording/reproducing device 100 is configured to satisfy the following conditions (7) and (8):

−0.02<f1×M1<0.02 (7)

−0.02<f2×M2<0.02 (8)

where M1 represents a total magnification of the objective optical system 30 defined when optical disc D1 is used, f2 represents a total focal length of the objective optical system 30 at the second design wavelength, and M2 represents total magnification of the objective optical system 30 defined when the optical disc D2 is used.

By designing the objective optical system 30 to satisfy the conditions (7) and (8), the laser beam used for the information recording/reproducing for each of the optical discs D1 and D2 becomes a substantially collimated beam. Therefore, it is possible to decrease the amount of a comma or astigmatism caused during the tracking operation while achieving the above mentioned optical performance of the objective optical system 30 (i.e., suitably correcting the longitudinal chromatic aberration and the spherical aberration). It should be noted that if the intermediate terms of the conditions (7) and (8) get larger than or equal to the respective upper limits of the conditions (7) and (8), a coma and astigmatism become excessively large in the tracking operation, and if the intermediate terms of the conditions (7) and (8) get smaller than or equal to the respective lower limits of the conditions (7) and (8), a coma and astigmatism become excessively large in the tracking operation.

In this embodiment, the light sources 1A and 1B are positioned such that the laser beams emitted by the light sources 1A and 1B are converted to collimated beams by the coupling lenses 3A and 3B, respectively. Therefore, each of the magnifications M1 and M2 is 0. In other words, each of the coupling lenses 3A and 3B functions as a collimator lens for the first and second laser beams.

As described above, in the case where the phase shift structure for effectively suppress the aberrations caused when each of the optical discs D1 and D2 having a relatively narrow tolerance to aberrations is provided on the objective lens 10, the spherical aberration remains when a collimated beam is used for the information recording/reproducing for the optical disc D3. For this reason, in this embodiment, the spherical aberration caused when the optical disc D3 is used is corrected by using a diverging beam as the being entering the objective optical system 30 when the optical disc D3 is used (see FIG. 2C).

More specifically, the objective optical system 30 is configured to satisfy the following condition (9):

−0.28<f3×M3<−0.18 (9)

where f3 represents a total focal length at the third design wavelength, M3 represents a total magnification at the third design wavelength.

If the intermediate term of the condition (9) gets larger than or equal to the upper limit of the condition (9), the spherical aberration in an over state remains when the optical disc D3 is used. If the intermediate term of the condition (9) gets lower than or equal to the lower limit of the condition (9), the spherical aberration in an under state is caused when the optical disc D3 is used. By configuring the objective optical system 30 to satisfy the condition (9), the spherical aberration can be suitably suppressed when the optical disc D3 is used.

### Second Embodiment

Hereafter, an optical information recording/reproducing device having an objective optical system according to a second embodiment of the invention is described. The optical information recording/reproducing device according to the second embodiment has basically the same structural configuration as that of the first embodiment shown in FIGS. 1, 2A-2C and FIGS. 3A and 3B. Therefore, in the following, only the feature of the second embodiment is explained, and FIGS. 1, 2A-2C and FIGS. 3A and 3B are also used to explain the second embodiment.

The phase shift structure formed on the objective lens 10 is configured to give a predetermined optical path length difference to the first laser beam so that the spherical aberration caused when each of the first and second laser beams is used can be suitably suppressed. More specifically, in the second embodiment, the phase shift structure formed on the objective lens 10 is configured to give an optical path length difference approximately equal to 3λ₁ to the first laser beam. In this case, the first design wavelength is assigned to λ of the optical path length difference function φi(h), and 3 is assigned to m of the optical path length difference function φj(h). By thus defining the values to be assigned to the optical path length difference function φj(h), it is possible to effectively suppress the spherical aberration caused when each of the first and second laser beams is incident on the objective lens 10 as a collimated beam.

The chromatic aberration correction element 20 functions as a longitudinal chromatic aberration correction element for appropriately controlling the amount of the longitudinal chromatic aberration caused when each of the first and second laser beams is used. The chromatic aberration correction element 20 is formed such that a positive lens and a negative lens of which materials are different from each other are cemented together. More specifically, the chromatic aberration correction element 20 is configured such that curved surfaces of the planoconcave lens 20a and the planoconvex lens 20b arranged in this order from the light source side are cemented together.

In order to achieve the function of controlling the amount of the longitudinal chromatic aberration cased when each of the optical discs D1 and D2 is used, the chromatic aberration correction element 20 is configured considering the following conditions (11), (12), (14) and (15).

$$\begin{matrix}0.43 < \frac{\{ ( nB 1 - nB 2 ) - ( nR 1 - nR 2 ) \} \{ ( f 1 / R ) + 0.008 N \}}{nB 3 - nR 3} < 1.38 & ( 11 ) \\ 0.68 < \frac{\{ ( nB 1 - nB 2 ) - ( nR 1 - nR 2 ) \} \{ ( f 1 / R ) + 0.008 N \}}{nB 3 - nR 3} < 1.13 & ( 12 ) \\ 0.25 < \frac{\{ ( nB 1 - nB 2 ) - ( nR 1 - nR 2 ) \} \{ ( f 1 / R ) - 0.03 {P}_{12} \}}{nB 3 - nR 3} < 1.19 & ( 14 ) \\ 0.48 < \frac{\{ ( nB 1 - nB 2 ) - ( nR 1 - nR 2 ) \} \{ ( f 1 / R ) - 0.03 {P}_{12} \}}{nB 3 - nR 3} < 0.98 & ( 15 )\end{matrix}$$

The conditions (11), (12), (14) and (15) are used to define, in regard to an axial power component of the surface 11 of the objective lens 10, the radius of curvature of the cementing surface 21 and materials of the planoconcave lens 20a and the planoconvex lens 20b forming the chromatic aberration correction element 20. By satisfying the condition (11) (or (14)), the longitudinal chromatic aberration caused when each of the optical discs D1 and D2 is used can be suitably corrected. By further satisfying the condition (12) (or (15)), the longitudinal chromatic aberration caused when each of the optical discs D1 and D2 is used can be corrected more suitably.

If the intermediate terms of the conditions (11) and (14) get lower than or equal to the respective lower limits of the conditions (11) and (14), the longitudinal chromatic aberration caused when the optical disc D1 is used becomes an undercorrected state. If the intermediate terms of the conditions (11) and (14) get larger than or equal to the respective upper limits of the conditions (11) and (14), the longitudinal chromatic aberration caused when the optical disc D2 is used becomes an overcorrected state.

In general, the higher the recording density of an optical disc becomes, the narrower the tolerance to aberrations becomes. In order to further lower the longitudinal chromatic aberration caused when the optical disc D1 is used, the objective optical system 30 may be configured to satisfy the following conditions (13) and (16).

$$\begin{matrix}0.80 < \frac{\{ ( nB 1 - nB 2 ) - ( nR 1 - nR 2 ) \} \{ ( f 1 / R ) + 0.014 N \}}{nB 3 - nR 3} < 1.13 & ( 13 ) \\ 0.45 < \frac{\{ ( nB 1 - nB 2 ) - ( nR 1 - nR 2 ) \} \{ ( f 1 / R ) - 0.06 {P}_{12} \}}{nB 3 - nR 3} < 0.86 & ( 16 )\end{matrix}$$

If the intermediate terms of the conditions (13) and (16) get lower than or equal to the respective lower limits of the conditions (13) and (16), the longitudinal chromatic aberration caused when the optical disc D1 is used becomes an undercorrected state. If the intermediate terms of the conditions (13) and (16) get larger than or equal to the respective upper limits of the conditions (13) and (16), the longitudinal chromatic aberration caused when the optical disc D1 is used becomes an overcorrected state.

In this embodiment, the materials of the planoconcave lens 20a and the planoconvex lens 20b are selected so that the above mentioned condition (10) is satisfied.

$$- 3.30 < \frac{nB 1 - nB 2}{nR 1 - nR 2} < - 0.30 \qquad ( 10 )$$

### By satisfying the condition (10), the same advantages as those explained in the first embodiment can also be achieved.

The optical information recording/reproducing device 100 may be configured to satisfy the above described conditions (7), (8) and (17).

−0.02<f1×M1<0.02 (7)

−0.02<f2×M2<0.02 (8)

−0.19<f3×M3<−0.05 (17)

### By satisfying the conditions (7), (8) and (17), the same advantages as those explained in the first embodiment can also be achieved.

Hereafter, a variation of the second embodiment is described. In this variation, the magnification of the objective lens 10 for the third laser beam is set to approximately zero, for example, by arranging the light source 1C so that the laser beam emitted from the light source 1C is converted to a collimated beam by the coupling lens 3C. That is, in this variation the coupling lens 3C also functions as a collimator lens as in the case of the coupling lenses 3A and the 3B. It is noted that in this case the optical information recording/reproducing device 100 according to this variation may be configured not to satisfy the condition (17). Even if the condition (17) is not satisfied, the same advantages as those of the second embodiment can be achieved.

In this variation, it is required to correct the spherical aberration caused depending on the change of the refractive index of the objective lens 10 due to wavelength differences among the first to third laser beams and the differences in protective layer thickness among the optical discs D1-D3. Therefore, in this variation the phase shift structure in the objective optical system 30 is configured to compensate for the change of the refractive index and the change of the spherical aberration. More specifically, the phase shift structure is configured to have at least two types of steps giving different optical path length differences to an incident beam. Such a phase shift structure is achieved by defining at least two types of optical path length difference functions. In this case, the two types of optical path length difference functions are determined such that a ratio defined, for the first type optical path length difference function, among diffraction orders at which the diffraction efficiencies of the first to third laser beams take the respective maximum values and a ratio defined, for the second type optical path length difference function, among diffraction orders at which the diffraction efficiencies of the first to third laser beams take the respective maximum values are different from each other.

One of the at least two types of steps (hereafter, referred to as a first step) gives an optical path length difference of approximately 3λ₁ to the first laser beam. That is, m1 of the optical path length difference function defining the first step is 3. If one of the at least two types of optical discs is configured to give, to the first laser beam, an optical path length difference corresponding to an odd multiple of the wavelength of the first laser beam as described above, the use efficiency of light may decrease particularly in information recording/reproducing for the optical disc D3. For this reason, the other step is configured to increase the use efficiency of light for the optical disc D3.

More specifically, the other step is configured to give, to the first laser beam, an optical path length difference approximately equal to an even multiple of the wavelength of the first light beam. With this configuration, it becomes possible to achieve the high use efficiency of light for the information recording/reproducing of each of the optical discs D1-D3.

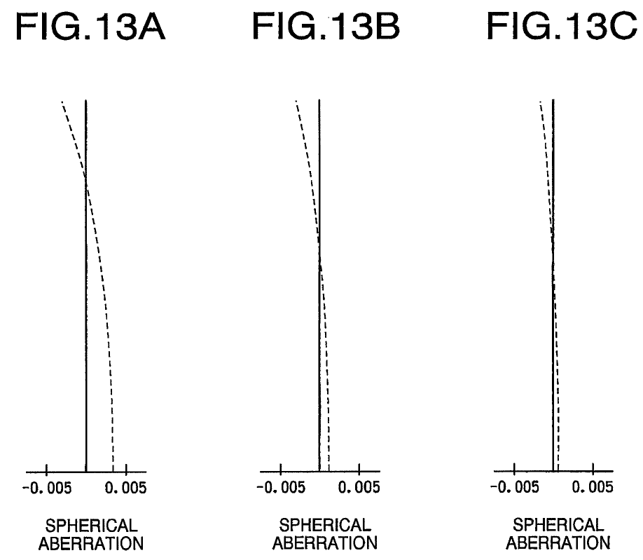

Hereafter, seven concrete examples (first to seventh examples) of the optical information recording/reproducing device 100 and comparative examples are described. The first to third examples correspond to the first embodiment, and the fourth to seventh examples correspond to the second embodiment. The optical information recording/reproducing device 100 according to each of the first to sixth examples has the configuration shown in FIGS. 1, 2A to 2C, 3A and 3B. Regarding the seventh example, FIGS. 13A to 13C respectively corresponding to FIGS. 2A to 2C are applied.

In each example, an aperture restricting element such as the aperture stop 60 shown in FIGS. 3A and 3B is used to obtain a suitable numerical aperture for the information recording/reproducing for the optical disc D3. Therefore, as show in FIGS. 2A to 2C, the beam diameter for the optical disc D3 is smaller than that for the optical disc D1 or D2.

In the following examples, the optical disc D1 having the highest recording density has the protective layer thickness (t1) of 0.6 mm, the optical disc D2 having the second highest recording density has the protective layer thickness (t2) of 0.6 mm, and the optical disc D3 having the lowest recording density has the protective layer thickness (t3) of 1.2 mm.

### First Example

The following Table 1 shows concrete specifications of the objective optical system 30 according to a first example.

TABLE 1

| | 1^{st} laser beam | 2^{nd} laser beam | 3^{rd} laser beam |
|---|---|---|---|
| Wavelength (nm) | 405 | 660 | 790 |
| Focal Length (mm) | 3.00 | 3.19 | 3.20 |
| NA | 0.65 | 0.60 | 0.47 |
| Magnification M | 0.000 | 0.000 | −0.078 |

As indicated by the “Magnification M” in Table 1, the laser beam is incident upon the chromatic aberration correction element 20 as a collimated beam when each of the optical discs D1 and D2 is used, and the laser beam is incident on the chromatic aberration correction element 20 as a diverging beam when the optical disc D3 is used.

Table 2 shows specific numerical configuration defined when the optical disc D1 is used in the optical information recording/reproducing device 100 provided with the objective optical system 30 shown in Table 1. The following Table 3 shows specific numerical configuration defined when the optical disc D2 is used in the optical information recording/reproducing device 100 provided with the objective optical system 30 shown in Table 1. The following Table 4 shows specific numerical configuration defined when the optical disc D3 is used in the optical information recording/reproducing device 100 provided with the objective optical system 30 show in Table 1.

TABLE 2

| Surface No. | r | d | n(405 nm) | Comments |
|---|---|---|---|---|
| 0 | | 2.81 | | light source |
| 1 | ∞ | 2.00 | 1.52972 | diffraction grating |
| 2 | ∞ | 13.00 | | |
| 3 | 85.710 | 1.50 | 1.52469 | coupling lens |
| 4 | −10.550 | 1.00 | | |
| 5 | ∞ | 4.00 | 1.52972 | beam splitter |
| 6 | ∞ | 1.00 | | |
| 7 | ∞ | 4.00 | 1.52972 | beam splitter |
| 8 | ∞ | 1.00 | | |
| 9 | ∞ | 1.00 | 1.81566 | chromatic aberration |
| 10 | 10.000 | 1.50 | 1.81656 | correction element |
| 11 | ∞ | 10.07 | | |
| 12 | 2.099 | 2.30 | 1.59966 | objective lens |
| 13 | −10.794 | 1.33 | | |
| 14 | ∞ | 0.60 | 1.62231 | optical disc |
| 15 | ∞ | — | | |

TABLE 3

| Surface No. | r | d | n(660 nm) | Comments |
|---|---|---|---|---|
| 0 | | 2.79 | | light source |
| 1 | ∞ | 2.00 | 1.51374 | diffraction grating |
| 2 | ∞ | 13.00 | | |
| 3 | 101.820 | 1.50 | 1.54044 | coupling lens |
| 4 | −10.700 | 1.00 | | |
| 5 | ∞ | 4.00 | 1.51374 | beam splitter |
| 6 | ∞ | 1.00 | | |
| 7 | ∞ | 4.00 | 1.51374 | beam splitter |
| 8 | ∞ | 1.00 | | |
| 9 | ∞ | 1.00 | 1.75320 | chromatic aberration |
| 10 | 10.000 | 1.50 | 1.78277 | correction element |
| 11 | ∞ | 10.00 | | |
| 12 | 2.099 | 2.30 | 1.58000 | objective lens |
| 13 | −10.794 | 1.40 | | |
| 14 | ∞ | 0.60 | 1.57961 | optical disc |
| 15 | ∞ | — | | |

TABLE 4

| Surface No. | r | d | n(790 nm) | Comments |
|---|---|---|---|---|
| 0 | | 2.67 | | light source |
| 1 | ∞ | 2.00 | 1.51052 | diffraction grating |
| 2 | ∞ | 5.00 | | |
| 3 | −15.220 | 1.50 | 1.53653 | coupling lens |
| 4 | −6.510 | 6.44 | | |
| 5 | ∞ | 4.00 | 1.51052 | beam splitter |
| 6 | ∞ | 1.00 | | |
| 7 | ∞ | 1.00 | 1.74345 | chromatic aberration |
| 8 | 10.000 | 1.50 | 1.77651 | correction element |
| 9 | ∞ | 10.15 | | |
| 10 | 2.099 | 2.30 | 1.57621 | objective lens |
| 11 | −10.794 | 1.25 | | |
| 12 | ∞ | 1.20 | 1.57307 | optical disc |
| 13 | ∞ | — | | |

In Tables 2 to 4, “r” denotes the curvature radius [mm] of each optical surface, “d” denotes the distance [mm] from each optical surface to the next optical surface during the information reproduction/recordation, “n (X nm)” denotes the refractive index of a medium between each optical surface and the next optical surface for a wavelength of X nm (ditto for the similar Tables explained later).

As shown in the “Comments” in Tables 2 to 4 (and in the following similar Tables), the surface No. 0 represents the light source (1A, 1B, 1C), the surfaces Nos. 1 and 2 represent surfaces of the diffraction grating (2A, 2B, 2C), and the surfaces Nos. 3 and 4 represent surfaces of the coupling lens (3A, 3B, 3C). In Tables 2 and 3, the surfaces Nos. 5 and 6 represent surfaces of the beam splitter 41, surfaces Nos. 7 and 8 represent surfaces of the beam splitter 42, surfaces Nos. 9, 10 and 11 respectively represent the surfaces of the chromatic aberration correction element 20, the surfaces 12 and 13 respectively represents the surfaces of the objective lens 10 and the surfaces Nos. 14 and 15 represent the protective layer 51 and the record surface 52 of the optical disc (D1, D2). In Table 4, the surfaces Nos. 5 and 6 represent surfaces of the beam splitter 42, surfaces Nos. 7, 8 and 9 respectively represent the surfaces of the chromatic aberration correction element 20, the surfaces Nos. 10 and 11 respectively represent the surfaces of the objective lens 10, and the surfaces 12 and 13 represent the protective layer 51 and the record surface 52 of the optical disc (D3).

A second surface of each of the coupling lenses 3A, 3B and 3C, and the first surface 11 and the second surface 12 of the objective lens 10 are aspherical surfaces. The following Table 5 shows the cone constant and aspherical coefficients specifying the shape of each aspherical surface when the optical disc D1 is used. The following Table 6 shows the cone constant and aspherical coefficients specifying the shape of each aspherical surface when the optical disc D2 is used. The following Table 7 shows the cone constant and aspherical coefficients specifying the shape of each aspherical surface when the optical disc D3 is used. Incidentally, the notation “E” in Tables 5-7 (and in the following similar Tables) means the power of 10 with an exponent specified by the number to the right of E (e.g. “E-04” means “×10⁻⁴”).

TABLE 5

| Surface No. | K | A4 | A6 | A8 | A10 | A12 |
|---|---|---|---|---|---|---|
| 4 | 0.0000 | 7.8520E−05 | 5.3350E−07 | 0.0000E+00 | 0.0000E+00 | 0.0000E+00 |
| 12 | −0.6000 | 3.4180E−03 | 2.5510E−04 | 4.7670E−05 | −3.0290E−06 | 1.8847E−06 |
| 13 | 0.0000 | 2.1230E−02 | −7.9950E−03 | 2.7500E−03 | −5.8610E−04 | 5.4590E−05 |

TABLE 6

| Surface No. | K | A4 | A6 | A8 | A10 | A12 |
|---|---|---|---|---|---|---|
| 4 | 0.0000 | 7.3130E−05 | 4.8300E−07 | 0.0000E+00 | 0.0000E+00 | 0.0000E+00 |
| 12 | −0.6000 | 3.4180E−03 | 2.5510E−04 | 4.7670E−05 | −3.0290E−06 | 1.8847E−06 |
| 13 | 0.0000 | 2.1230E−02 | −7.9950E−03 | 2.7500E−03 | −5.8610E−04 | 5.4590E−05 |

TABLE 7

| Surface No. | K | A4 | A6 | A8 | A10 | A12 |
|---|---|---|---|---|---|---|
| 4 | 0.0000 | 2.1660E−05 | 5.9000E−07 | 0.0000E+00 | 0.0000E+00 | 0.0000E+00 |
| 10 | −0.6000 | 3.4180E−03 | 2.5510E−04 | 4.7670E−05 | −3.0290E−06 | 1.8847E−06 |
| 11 | 0.0000 | 2.1230E−02 | −7.9950E−03 | 2.7500E−03 | −5.8610E−04 | 5.4590E−05 |

Table 8 shows coefficients P₂, . . . of the optical path length difference function defining the phase shift structure formed on the first surface 11 of the objective lens 10 according to the first example. Table 9 shows the diffraction order m at which the diffraction efficiency is maximized for each of the first to third laser beams. As shown in Table 9, the diffraction order m varies depending on the type of the laser beams. In Tables 8 and 9 (and in the following similar Tables), for the sake of simplicity, a numeral subscript “i” is omitted when the phase shift structure is defined by one optical path length difference function.

TABLE 8

| | P2 | P4 | P6 | P8 | P10 | P12 |
|---|---|---|---|---|---|---|
| First Surface | −1.0000E+01 | 5.6180E−01 | −3.6770E−03 | 1.7320E−02 | 0.0000E+00 | 0.0000E+00 |

TABLE 9

| | 1^{st} Laser | 2^{nd} Laser | 3^{rd} Laser |
|---|---|---|---|
| diffraction order m | 2 | 1 | 1 |

As can be seen from the above described Tables, values of the intermediate terms of the conditions (4) and (5) are 0.875, and the value of the intermediate term of the condition (6) is 1.312. Therefore, conditions (4), (5) and (6) are satisfied.

Table 10 shows a concrete configuration of the phase shift structure formed on the first surface 11 of the objective lens 10. In Table 10, a range of each of annular zones is indicated, numbers are assigned to annular zones in ascending order with respect to the optical axis, and each range of the annular zones is represented by heights hmin and hmax from the optical axis.

TABLE 10

| Number | hmin | hmax |
|---|---|---|
| 0 | 0.000 | 0.224 |
| 1 | 0.224 | 0.389 |
| 2 | 0.389 | 0.504 |
| 3 | 0.504 | 0.598 |
| 4 | 0.598 | 0.680 |
| 5 | 0.680 | 0.754 |
| 6 | 0.754 | 0.822 |
| 7 | 0.822 | 0.886 |
| 8 | 0.886 | 0.947 |
| 9 | 0.947 | 1.004 |
| 10 | 1.004 | 1.060 |
| 11 | 1.060 | 1.113 |
| 12 | 1.113 | 1.166 |
| 13 | 1.166 | 1.217 |
| 14 | 1.217 | 1.267 |
| 15 | 1.267 | 1.316 |
| 16 | 1.316 | 1.365 |
| 17 | 1.365 | 1.414 |
| 18 | 1.414 | 1.463 |
| 19 | 1.463 | 1.512 |
| 20 | 1.512 | 1.562 |
| 21 | 1.562 | 1.614 |
| 22 | 1.614 | 1.667 |
| 23 | 1.667 | 1.724 |
| 24 | 1.724 | 1.785 |
| 25 | 1.785 | 1.857 |
| 26 | 1.857 | 1.950 |

As shown in Table 10, the number N of annular zones within the effective diameter of the first surface 11 of the objective lens 10 is 27. In this case, the values of the intermediate terms of the conditions (1) and (2) are 0.752. The value of the intermediate term of the condition (3) is 0.989. Therefore, the conditions (1), (2) and (3) are satisfied. As can be see from Table 1, f1×M1 is 0.000, f2×M2 is 0.000, and f3×M3 is −0.250. Therefore, conditions (7), (8) and (9) are satisfied.

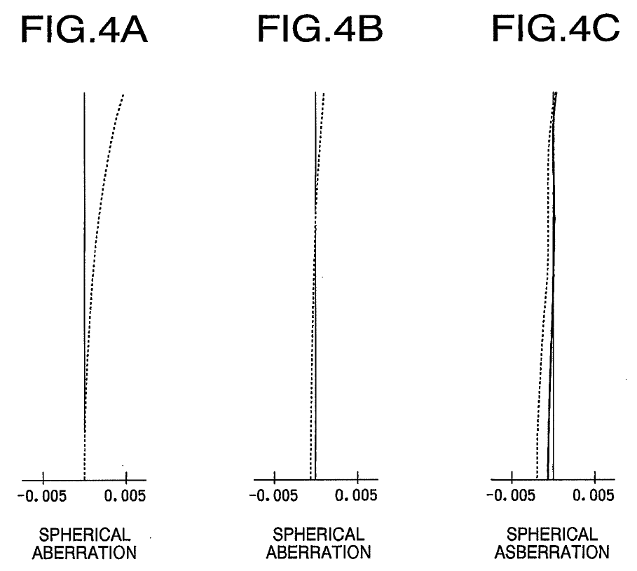

FIG. 4A is a graph illustrating the spherical aberration caused when the first laser beam is used in the optical information recording/reproducing device 100 according to the first example. FIG. 4B is a graph illustrating the spherical aberration caused when the second laser beam is used in the optical information recording/reproducing device 100 according to the first example. FIG. 4C is a graph illustrating the spherical aberration caused when the third laser beam is used in the optical information recording/reproducing device 100 according to the first example.

In each of FIGS. 4A-4C (and in the following similar graphs), a solid line represents the spherical aberration at the design wavelength, and a dashed line represents the spherical aberration at a wavelength shifted by +10 nm from the design wavelength.

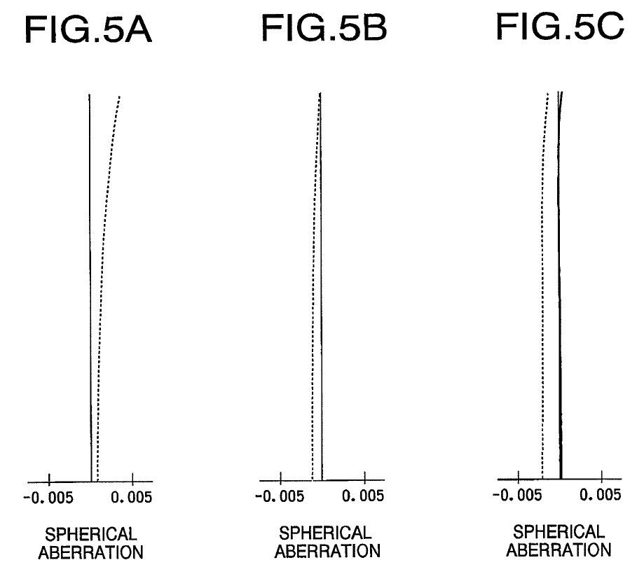

FIGS. 5A, 5B and 5C show spherical aberrations caused in an optical information recording/reproducing device according to a comparative example. FIG. 5A is a graph illustrating the spherical aberration caused when the first laser beam is used in the optical information recording/reproducing device according to the comparative example. FIG. 5B is a graph illustrating the spherical aberration caused when the second laser beam is used in the optical information recording/reproducing device according to the comparative example. FIG. 5C is a graph illustrating the spherical aberration caused when the third laser beam is used in the optical information recording/reproducing device according to the comparative example. The comparative example is configured such that, in the configuration of the optical information recording/reproducing device 100, the objective optical system 30 is replaced with a single objective lens.

By comparing FIGS. 4A, 4B and 4C with FIGS. 5A, 5B and 5C, it is understood that the optical information recording/reproducing device 100 having the objective optical system 30 is able to suitably correct the longitudinal chromatic aberration for each of the optical discs D1 and D2 in comparison with the comparative example. In addition, the optical information recording/reproducing device 100 is able to suitably correct the spherical aberration for each of the optical discs D1, D2 and D3. That is, the optical information recording/reproducing device 100 is able to form a beam spot suitable for information recording/reproducing of each of the optical discs D1, D2 and D3.

### Second Example

The following Table 11 shows concrete specifications of the objective optical system 30 according to a second example.

TABLE 11

| | 1^{st} laser beam | 2^{nd} laser beam | 3^{rd} laser beam |
|---|---|---|---|
| Wavelength (nm) | 405 | 660 | 790 |
| Focal Length (mm) | 3.00 | 3.21 | 3.21 |
| NA | 0.65 | 0.60 | 0.47 |
| Magnification M | 0.000 | 0.000 | −0.081 |

As indicated by the “Magnification M” in Table 11, the laser beam is incident upon the chromatic aberration correction element 20 as a collimated beam when each of the optical discs D1 and D2 is used, and the laser beam is incident on the chromatic aberration correction element 20 as a diverging beam when the optical disc D3 is used.

Table 12 shows specific numerical configuration defined when the optical disc D1 is used in the optical information recording/reproducing device 100 provided with the objective optical system 30 shown in Table 11. The following Table 13 shows specific numerical configuration defined when the optical disc D2 is used in the optical information recording/reproducing device 100 provided with the objective optical system 30 shown in Table 11. The following Table 14 shows specific numerical configuration defined when the optical disc D3 is used in the optical information recording/reproducing device 100 provided with the objective optical system 30 shown in Table 11.

TABLE 12

| Surface No. | r | d | n(405 nm) | Comments |
|---|---|---|---|---|
| 0 | | 2.81 | | light source |
| 1 | ∞ | 2.00 | 1.52972 | diffraction grating |
| 2 | ∞ | 13.00 | | |
| 3 | 85.710 | 1.50 | 1.52469 | coupling lens |
| 4 | −10.550 | 1.00 | | |
| 5 | ∞ | 4.00 | 1.52972 | beam splitter |
| 6 | ∞ | 1.00 | | |
| 7 | ∞ | 4.00 | 1.52972 | beam splitter |
| 8 | ∞ | 1.00 | | |
| 9 | ∞ | 1.00 | 1.82201 | chromatic aberration |
| 10 | 4.000 | 1.50 | 1.81656 | correction element |
| 11 | ∞ | 10.09 | | |
| 12 | 2.092 | 2.30 | 1.56023 | objective lens |
| 13 | −7.879 | 1.38 | | |
| 14 | ∞ | 0.60 | 1.62231 | optical disc |
| 15 | ∞ | — | | |

TABLE 13

| Surface No. | r | d | n(660 nm) | Comments |
|---|---|---|---|---|
| 0 | | 2.79 | | light source |
| 1 | ∞ | 2.00 | 1.51374 | diffraction grating |
| 2 | ∞ | 13.00 | | |
| 3 | 101.820 | 1.50 | 1.54044 | coupling lens |
| 4 | −10.700 | 1.00 | | |
| 5 | ∞ | 4.00 | 1.51374 | beam splitter |
| 6 | ∞ | 1.00 | | |
| 7 | ∞ | 4.00 | 1.51374 | beam splitter |
| 8 | ∞ | 1.00 | | |
| 9 | ∞ | 1.00 | 1.77637 | chromatic aberration |
| 10 | 4.000 | 1.50 | 1.78277 | correction element |
| 11 | ∞ | 10.00 | | |
| 12 | 2.092 | 2.30 | 1.54044 | objective lens |
| 13 | −7.879 | 1.47 | | |
| 14 | ∞ | 0.60 | 1.57961 | optical disc |
| 15 | ∞ | — | | |

TABLE 14

| Surface No. | r | d | n(790 nm) | Comments |
|---|---|---|---|---|
| 0 | | 2.30 | | light source |
| 1 | ∞ | 2.00 | 1.51052 | diffraction grating |
| 2 | ∞ | 5.00 | | |
| 3 | −14.102 | 1.50 | 1.53653 | coupling lens |
| 4 | −6.320 | 6.68 | | |
| 5 | ∞ | 4.00 | 1.51052 | beam splitter |
| 6 | ∞ | 1.00 | | |
| 7 | ∞ | 1.00 | 1.76870 | chromatic aberration |
| 8 | 4.000 | 1.50 | 1.77651 | correction element |
| 9 | ∞ | 10.14 | | |
| 10 | 2.092 | 2.30 | 1.53653 | objective lens |
| 11 | −7.879 | 1.33 | | |
| 12 | ∞ | 1.20 | 1.57307 | optical disc |
| 13 | ∞ | — | | |

A second surface of each of the coupling lenses 3A, 3B and 3C, and the first surface 11 and the second surface 12 of the objective lens 10 are aspherical surfaces. The following Table 15 shows the cone constant and aspherical coefficients specifying the shape of each aspherical surface when the optical disc D1 is used. The following Table 16 shows the cone constant and aspherical coefficients specifying the shape of each aspherical surface when the optical disc D2 is used. The following Table 17 shows the cone constant and aspherical coefficients specifying the shape of each aspherical surface when the optical disc D3 is used.

TABLE 15

| Surface No. | K | A4 | A6 | A8 | A10 | A12 |
|---|---|---|---|---|---|---|
| 4 | 0.0000 | 7.8520E−05 | 5.3350E−07 | 0.0000E+00 | 0.0000E+00 | 0.0000E+00 |
| 12 | −0.6000 | 3.2270E−03 | 1.8420E−04 | 4.1690E−05 | −4.5050E−06 | 1.9410E−06 |
| 13 | 0.0000 | 2.3870E−02 | −9.1670E−03 | 3.0710E−03 | −6.2550E−04 | 5.5910E−05 |

TABLE 16

| Surface No. | K | A4 | A6 | A8 | A10 | A12 |
|---|---|---|---|---|---|---|
| 4 | 0.0000 | 7.3130E−05 | 4.8300E−07 | 0.0000E+00 | 0.0000E+00 | 0.0000E+00 |
| 12 | −0.6000 | 3.2270E−03 | 1.8420E−04 | 4.1690E−05 | −4.5050E−06 | 1.9410E−06 |
| 13 | 0.0000 | 2.3870E−02 | −9.1670E−03 | 3.0710E−03 | −6.2550E−04 | 5.5910E−05 |

TABLE 17

| Surface No. | K | A4 | A6 | A8 | A10 | A12 |
|---|---|---|---|---|---|---|
| 4 | 0.0000 | 1.7400E−05 | 5.0000E−07 | 0.0000E+00 | 0.0000E+00 | 0.0000E+00 |
| 10 | −0.6000 | 3.2270E−03 | 1.8420E−04 | 4.1690E−05 | −4.5050E−06 | 1.9410E−06 |
| 11 | 0.0000 | 2.3870E−02 | −9.1670E−03 | 3.0710E−03 | −6.2550E−04 | 5.5910E−05 |

Table 18 shows coefficients P₂, . . . of the optical path length difference function defining the phase shift structure formed on the first surface 11 of the objective lens 10 according to the second example. Table 19 shows the diffraction order m at which the diffraction efficiency is maximized for each of the first to third laser beams. As shown in Table 19, the diffraction order m varies depending on the type of the laser beams.

TABLE 18

| | P2 | P4 | P6 | P8 | P10 | P12 |
|---|---|---|---|---|---|---|
| First Surface | −1.3000E+01 | 4.7180E−01 | −2.9210E−02 | 2.0740E−02 | 0.0000E+00 | 0.0000E+00 |

TABLE 19

| | 1^{st} Laser | 2^{nd} Laser | 3^{rd} Laser |
|---|---|---|---|
| diffraction order m | 2 | 1 | 1 |

As can be seen from the above described Tables, values of the intermediate terms of the conditions (4) and (5) are 0.683, and the value of the intermediate term of the condition (6) is 0.916. Therefore, the objective optical system according to the second example satisfies the condition (4).

Table 20 shows a concrete configuration of the phase shift structure formed on the first surface 11 of the objective lens 10. In Table 20, a range of each of annular zones is indicated, numbers are assigned to annular zones in ascending order with respect to the optical axis, and each range of the annular zones is represented by heights hmin and hmax from the optical axis.

TABLE 20

| number | hmin | hmax |
|---|---|---|
| 0 | 0.000 | 0.196 |
| 1 | 0.196 | 0.340 |
| 2 | 0.340 | 0.440 |
| 3 | 0.440 | 0.521 |
| 4 | 0.521 | 0.592 |
| 5 | 0.592 | 0.655 |
| 6 | 0.655 | 0.714 |
| 7 | 0.714 | 0.768 |
| 8 | 0.768 | 0.818 |
| 9 | 0.818 | 0.866 |
| 10 | 0.866 | 0.912 |
| 11 | 0.912 | 0.956 |
| 12 | 0.956 | 0.998 |
| 13 | 0.998 | 1.039 |
| 14 | 1.039 | 1.079 |
| 15 | 1.079 | 1.117 |
| 16 | 1.117 | 1.155 |
| 17 | 1.155 | 1.191 |
| 18 | 1.191 | 1.227 |
| 19 | 1.227 | 1.262 |
| 20 | 1.262 | 1.297 |
| 21 | 1.297 | 1.331 |
| 22 | 1.331 | 1.364 |
| 23 | 1.364 | 1.397 |
| 24 | 1.397 | 1.430 |
| 25 | 1.430 | 1.463 |
| 26 | 1.463 | 1.495 |
| 27 | 1.495 | 1.527 |
| 28 | 1.527 | 1.559 |
| 29 | 1.559 | 1.591 |
| 30 | 1.591 | 1.623 |
| 31 | 1.623 | 1.655 |
| 32 | 1.655 | 1.687 |
| 33 | 1.687 | 1.720 |
| 34 | 1.720 | 1.753 |
| 35 | 1.753 | 1.787 |
| 36 | 1.787 | 1.822 |
| 37 | 1.822 | 1.858 |
| 38 | 1.858 | 1.895 |
| 39 | 1.895 | 1.950 |

As shown in Table 20, the number N of annular zones within the effective diameter of the first surface 11 of the objective lens 10 is 40. In this case, the values of the intermediate terms of the conditions (1) and (2) are 0.641. The value of the intermediate term of the condition (3) is 0.784. Therefore, the objective optical system 30 according to the second example satisfies the conditions (1). As can be see from Table 11, f1×M1 is 0.000, f2×M2 is 0.000, and f3×M3 is −0.260. Therefore, conditions (7), (8) and (9) are satisfied. As can be seen from tables 12 and 13, the value of (nB1−nB2)/(nR1−nR2) is −0.852. Therefore, condition (10) is satisfied.

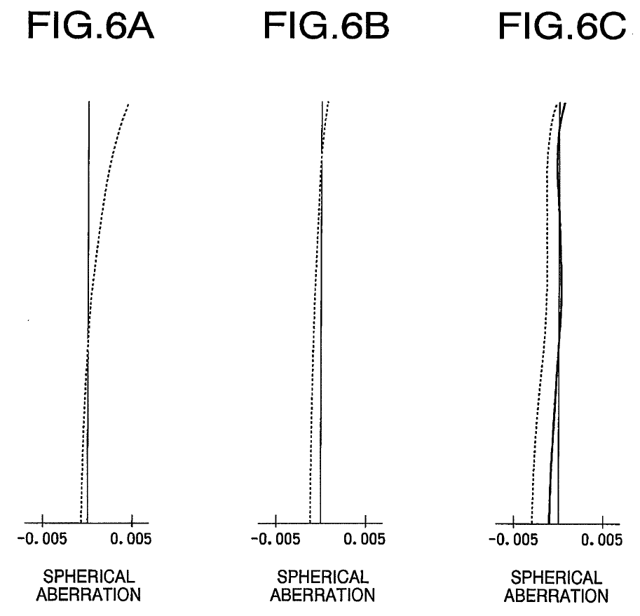

FIG. 6A is a graph illustrating the spherical aberration caused when the first laser beam is used in the optical information recording/reproducing device 100 according to the second example. FIG. 6B is a graph illustrating the spherical aberration caused when the second laser beam is used in the optical information recording/reproducing device 100 according to the second example. FIG. 6C is a graph illustrating the spherical aberration caused when the third laser beam is used in the optical information recording/reproducing device 100 according to the second example.

As shown in FIGS. 6A, 6B and 6C, the optical information recording/reproducing device 100 having the objective optical system 30 is able to suitably correct the longitudinal chromatic aberration for each of the optical discs D1 and D2. In addition, the optical information recording/reproducing device 100 is able to suitably correct the spherical aberration for each of the optical discs D1, D2 and D3. That is, the optical information recording/reproducing device 100 is able to form a beam spot suitable for information recording/reproducing of each of the optical discs D1, D2 and D3.

### Third Example

The following Table 21 shows concrete specifications of the objective optical system 30 according to a third example.

TABLE 21

| | 1^{st} laser beam | 2^{nd} laser beam | 3^{rd} laser beam |
|---|---|---|---|
| Wavelength (nm) | 405 | 660 | 790 |
| Focal Length (mm) | 2.30 | 2.44 | 2.44 |
| NA | 0.65 | 0.60 | 0.47 |
| Magnification M | 0.000 | 0.000 | −0.112 |

As indicated by the “Magnification M” in Table 21, the laser beam is incident upon the chromatic aberration correction element 20 as a collimated beam when each of the optical discs D1 and D2 is used, and the laser beam is incident on the chromatic aberration correction element 20 as a diverging beam when the optical disc D3 is used.

Table 22 shows specific numerical configuration defined when the optical disc D1 is used in the optical information recording/reproducing device 100 provided with the objective optical system 30 shown in Table 21. The following Table 23 shows specific numerical configuration defined when the optical disc D2 is used in the optical information recording/reproducing device 100 provided with the objective optical system 30 shown in Table 21. The following Table 24 shows specific numerical configuration defined when the optical disc D3 is used in the optical information recording/reproducing device 100 provided with the objective optical system 30 shown in Table 21.

TABLE 22

| Surface No. | r | d | n(405 nm) | Comments |
|---|---|---|---|---|
| 0 | | 2.81 | | light source |
| 1 | ∞ | 2.00 | 1.52972 | diffraction grating |
| 2 | ∞ | 13.00 | | |
| 3 | 85.710 | 1.50 | 1.52469 | coupling lens |
| 4 | −10.550 | 1.00 | | |
| 5 | ∞ | 3.20 | 1.52972 | beam splitter |
| 6 | ∞ | 1.00 | | |
| 7 | ∞ | 3.20 | 1.52972 | beam splitter |
| 8 | ∞ | 1.00 | | |
| 9 | ∞ | 1.00 | 1.72925 | chromatic aberration |
| 10 | 5.000 | 1.50 | 1.71793 | correction element |
| 11 | ∞ | 5.06 | | |
| 12 | 1.566 | 1.75 | 1.52469 | objective lens |
| 13 | −4.477 | 1.00 | | |
| 14 | ∞ | 0.60 | 1.62231 | optical disc |
| 15 | ∞ | — | | |

TABLE 23

| Surface No. | r | d | n(660 nm) | Comments |
|---|---|---|---|---|
| 0 | | 2.79 | | light source |
| 1 | ∞ | 2.00 | 1.51374 | diffraction grating |
| 2 | ∞ | 13.00 | | |
| 3 | 101.820 | 1.50 | 1.54044 | coupling lens |
| 4 | −10.700 | 1.00 | | |
| 5 | ∞ | 3.20 | 1.51374 | beam splitter |
| 6 | ∞ | 1.00 | | |
| 7 | ∞ | 3.20 | 1.51374 | beam splitter |
| 8 | ∞ | 1.00 | | |
| 9 | ∞ | 1.00 | 1.68219 | chromatic aberration |
| 10 | 5.000 | 1.50 | 1.69280 | correction element |
| 11 | ∞ | 5.00 | | |
| 12 | 1.566 | 1.75 | 1.50635 | objective lens |
| 13 | −4.477 | 1.06 | | |
| 14 | ∞ | 0.60 | 1.57961 | optical disc |
| 15 | ∞ | — | | |

TABLE 24

| Surface No. | r | d | n(790 nm) | Comments |
|---|---|---|---|---|
| 0 | | 1.61 | | light source |
| 1 | ∞ | 2.00 | 1.51052 | diffraction grating |
| 2 | ∞ | 1.00 | | |
| 3 | −5.304 | 1.50 | 1.53653 | coupling lens |
| 4 | −3.900 | 6.23 | | |
| 5 | ∞ | 3.20 | 1.51052 | beam splitter |
| 6 | ∞ | 1.00 | | |
| 7 | ∞ | 1.00 | 1.67450 | chromatic aberration |
| 8 | 5.000 | 1.50 | 1.68790 | correction element |
| 9 | ∞ | 5.14 | | |
| 10 | 1.566 | 1.75 | 1.50313 | objective lens |
| 11 | −4.477 | 0.92 | | |
| 12 | ∞ | 1.20 | 1.57307 | optical disc |
| 13 | ∞ | — | | |

A second surface of each of the coupling lenses 3A, 3B and 3C, and the first surface 11 and the second surface 12 of the objective lens 10 are aspherical surfaces. The following Table 25 shows the cone constant and aspherical coefficients specifying the shape of each aspherical surface when the optical disc D1 is used. The following Table 26 shows the cone constant and aspherical coefficients specifying the shape of each aspherical surface when the optical disc D2 is used. The following Table 27 shows the cone constant and aspherical coefficients specifying the shape of each aspherical surface when the optical disc D3 is used.

TABLE 25

| Surface No. | K | A4 | A6 | A8 | A10 | A12 |
|---|---|---|---|---|---|---|
| 4 | 0.0000 | 7.8520E−05 | 5.3350E−07 | 0.0000E+00 | 0.0000E+00 | 0.0000E+00 |
| 12 | −0.6000 | 3.4450E−03 | 1.4550E−03 | 2.5680E−04 | 6.9680E−05 | −7.7300E−06 |
| 13 | 0.0000 | 3.8910E−02 | −5.9930E−03 | −1.3070E−03 | 9.0130E−04 | −1.4550E−04 |

TABLE 26

| Surface No. | K | A4 | A6 | A8 | A10 | A12 |
|---|---|---|---|---|---|---|
| 4 | 0.0000 | 7.3130E−05 | 4.8300E−07 | 0.0000E+00 | 0.0000E+00 | 0.0000E+00 |
| 12 | −0.6000 | 3.4450E−03 | 1.4550E−03 | 2.5680E−04 | 6.9680E−05 | −7.7300E−06 |
| 13 | 0.0000 | 3.8910E−02 | −5.9930E−03 | −1.3070E−03 | 9.0130E−04 | −1.4550E−04 |

TABLE 27

| Surface No. | K | A4 | A6 | A8 | A10 | A12 |
|---|---|---|---|---|---|---|
| 4 | 0.0000 | −2.4540E−04 | −2.0670E−05 | −8.8980E−07 | −2.1670E−07 | 0.0000E+00 |
| 10 | −0.6000 | 3.4450E−03 | 1.4550E−03 | 2.5680E−04 | 6.9680E−05 | −7.7300E−06 |
| 11 | 0.0000 | 3.8910E−02 | −5.9930E−03 | −1.3070E−03 | 9.0130E−04 | −1.4550E−04 |

Table 28 shows coefficients P₂, . . . of the optical path length difference function defining the phase shift structure formed on the first surface 11 of the objective lens 10 according to the third example. Table 29 shows the diffraction order m at which the diffraction efficiency is maximized for each of the first to third laser beams. As shown in Table 29, the diffraction order m varies depending on the type of the laser beams.

TABLE 28

| | P2 | P4 | P6 | P8 | P10 | P12 |
|---|---|---|---|---|---|---|
| First Surface | −1.7000E+01 | 5.7010E−01 | 6.5170E−01 | −8.0000E−04 | 0.0000E+00 | 0.0000E+00 |

TABLE 29

| | 1^{st} Laser | 2^{nd} Laser | 3^{rd} Laser |
|---|---|---|---|
| diffraction order m | 2 | 1 | 1 |

As can be seen from the above described Tables, values of the intermediate terms of the conditions (4) and (5) are 1.160, and the value of the intermediate term of the condition (6) is 1.770. Therefore, the objective optical system 30 according to the third example satisfies the conditions (4), (5) and (6).

Table 30 shows a concrete configuration of the phase shift structure formed on the first surface 11 of the objective lens 10. In Table 30, a range of each of annular zones is indicated, numbers are assigned to annular zones in ascending order with respect to the optical axis, and each range of the annular zones is represented by heights hmin and hmax from the optical axis.

TABLE 30

| Number | hmin | hmax |
|---|---|---|
| 0 | 0.000 | 0.172 |
| 1 | 0.172 | 0.298 |
| 2 | 0.298 | 0.385 |
| 3 | 0.385 | 0.456 |
| 4 | 0.456 | 0.518 |
| 5 | 0.518 | 0.573 |
| 6 | 0.573 | 0.624 |
| 7 | 0.624 | 0.672 |
| 8 | 0.672 | 0.717 |
| 9 | 0.717 | 0.760 |
| 10 | 0.760 | 0.801 |
| 11 | 0.801 | 0.841 |
| 12 | 0.841 | 0.879 |
| 13 | 0.879 | 0.917 |
| 14 | 0.917 | 0.954 |
| 15 | 0.954 | 0.990 |
| 16 | 0.990 | 1.026 |
| 17 | 1.026 | 1.061 |
| 18 | 1.061 | 1.097 |
| 19 | 1.097 | 1.133 |
| 20 | 1.133 | 1.169 |
| 21 | 1.169 | 1.205 |
| 22 | 1.205 | 1.243 |
| 23 | 1.243 | 1.282 |
| 24 | 1.282 | 1.322 |
| 25 | 1.322 | 1.365 |
| 26 | 1.365 | 1.413 |
| 27 | 1.413 | 1.469 |
| 28 | 1.469 | 1.520 |

As shown in Table 30, the number N of annular zones within the effective diameter of the first surface 11 of the objective lens 10 is 29. In this case, the values of the intermediate terms of the conditions (1) and (2) are 0.827. The value of the intermediate term of the condition (3) is 1.036. Therefore, the objective optical system 30 according to the third example satisfies the conditions (1) to (3). As can be see from Table 21, f1×M1 is 0.000, f2×M2 is 0.000, and f3×M3 is −0.273. Therefore, conditions (7) to (9) are satisfied. As can be seen from tables 22 and 23, the value of (nB1−nB2)/(nR1−nR2) is −1.067. Therefore, condition (10) is satisfied.

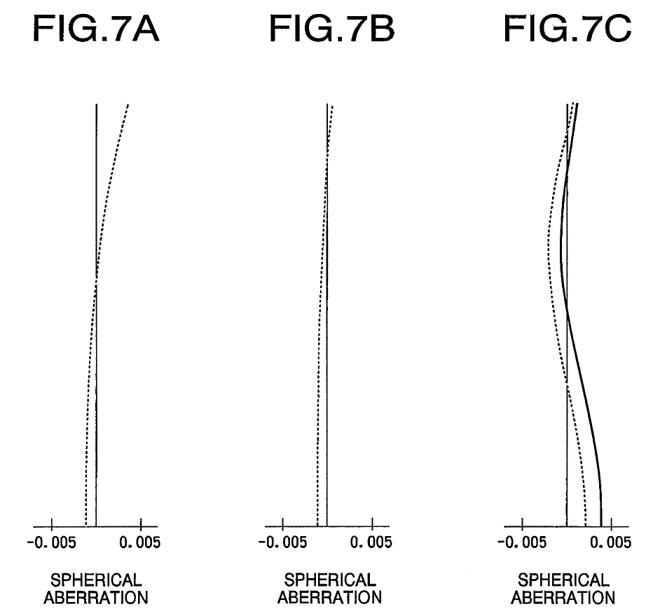

FIG. 7A is a graph illustrating the spherical aberration caused when the first laser beam is used in the optical information recording/reproducing device 100 according to the third example. FIG. 7B is a graph illustrating the spherical aberration caused when the second laser beam is used in the optical information recording/reproducing device 100 according to the third example. FIG. 7C is a graph illustrating the spherical aberration caused when the third laser beam is used in the optical information recording/reproducing device 100 according to the third example.

As shown in FIGS. 7A, 7B and 7C, the optical information recording/reproducing device 100 having the objective optical system 30 is able to suitably correct the longitudinal chromatic aberration for each of the optical discs D1 and D2. In addition, the optical information recording/reproducing device 100 is able to suitably correct the spherical aberration for each of the optical discs D1, D2 and D3. That is, the optical information recording/reproducing device 100 is able to form a beam spot suitable for information recording/reproducing of each of the optical discs D1, D2 and D3.

### Fourth Example

The following Table 31 shows concrete specifications of the objective optical system 30 according to a fourth example.

TABLE 31

| | 1^{st} laser beam | 2^{nd} laser beam | 3^{rd} laser beam |
|---|---|---|---|
| Wavelength (nm) | 405 | 660 | 790 |
| Focal Length (mm) | 3.03 | 3.17 | 3.20 |
| NA | 0.65 | 0.60 | 0.47 |
| Magnification M | 0.000 | 0.000 | −0.024 |

As indicated by the “Magnification M” in Table 31, the laser beam is incident upon the chromatic aberration correction element 20 as a collimated beam when each of the optical discs D1 and D2 is used, and the laser beam is incident on the chromatic aberration correction element 20 as a diverging beam when the optical disc D3 is used.

Table 32 shows specific numerical configuration defined when the optical disc D1 is used in the optical information recording/reproducing device 100 provided with the objective optical system 30 shown in Table 31. The following Table 33 shows specific numerical configuration defined when the optical disc D2 is used in the optical information recording/reproducing device 100 provided with the objective optical system 30 shown in Table 31. The following Table 34 shows specific numerical configuration defined when the optical disc D3 is used in the optical information recording/reproducing device 100 provided with the objective optical system 30 shown in Table 31.

TABLE 32

| Surface No. | r | d | n(405 nm) | Comments |
|---|---|---|---|---|
| 0 | | 2.81 | | light source |
| 1 | ∞ | 2.00 | 1.52972 | diffraction grating |
| 2 | ∞ | 13.00 | | |
| 3 | 85.710 | 1.50 | 1.52469 | coupling lens |
| 4 | −10.550 | 1.00 | | |
| 5 | ∞ | 4.00 | 1.52972 | beam splitter |
| 6 | ∞ | 1.00 | | |
| 7 | ∞ | 4.00 | 1.52972 | beam splitter |
| 8 | ∞ | 1.00 | | |
| 9 | ∞ | 1.00 | 1.81566 | chromatic aberration |
| 10 | 7.000 | 1.50 | 1.81656 | correction element |
| 11 | ∞ | 5.04 | | |
| 12 | 2.003 | 2.30 | 1.59966 | objective lens |
| 13 | −11.113 | 1.35 | | |
| 14 | ∞ | 0.60 | 1.62231 | optical disc |
| 15 | ∞ | — | | |

TABLE 33

| Surface No. | r | d | n(660 nm) | Comments |
|---|---|---|---|---|
| 0 | | 2.79 | | light source |
| 1 | ∞ | 2.00 | 1.51374 | diffraction grating |
| 2 | ∞ | 13.00 | | |
| 3 | 101.820 | 1.50 | 1.54044 | coupling lens |
| 4 | −10.700 | 1.00 | | |
| 5 | ∞ | 4.00 | 1.51374 | beam splitter |
| 6 | ∞ | 1.00 | | |
| 7 | ∞ | 4.00 | 1.51374 | beam splitter |
| 8 | ∞ | 1.00 | | |
| 9 | ∞ | 1.00 | 1.75320 | chromatic aberration |
| 10 | 7.000 | 1.50 | 1.78277 | correction element |
| 11 | ∞ | 5.00 | | |
| 12 | 2.003 | 2.30 | 1.58000 | objective lens |
| 13 | −11.113 | 1.39 | | |
| 14 | ∞ | 0.60 | 1.57961 | optical disc |
| 15 | ∞ | — | | |

TABLE 34

| Surface No. | r | d | n(790 nm) | Comments |
|---|---|---|---|---|
| 0 | | 2.74 | | light source |
| 1 | ∞ | 2.00 | 1.51052 | diffraction grating |
| 2 | ∞ | 12.00 | | |
| 3 | −217.200 | 1.50 | 1.53653 | coupling lens |
| 4 | −10.250 | 6.99 | | |
| 5 | ∞ | 4.00 | 1.51052 | beam splitter |
| 6 | ∞ | 1.00 | | |
| 7 | ∞ | 1.00 | 1.74345 | chromatic aberration |
| 8 | 7.000 | 1.50 | 1.77651 | correction element |
| 9 | ∞ | 5.30 | | |
| 10 | 2.003 | 2.30 | 1.57621 | objective lens |
| 11 | −11.113 | 1.09 | | |
| 12 | ∞ | 1.20 | 1.57307 | optical disc |
| 13 | ∞ | — | | |

A second surface of each of the coupling lenses 3A, 3B and 3C, and the first surface 11 and the second surface 12 of the objective lens 10 are aspherical surfaces. The following Table 35 shows the cone constant and aspherical coefficients specifying the shape of each aspherical surface when the optical disc D1 is used. The following Table 36 shows the cone constant and aspherical coefficients specifying the shape of each aspherical surface when the optical disc D2 is used. The following Table 37 shows the cone constant and aspherical coefficients specifying the shape of each aspherical surface when the optical disc D3 is used.

TABLE 35

| Surface No. | K | A4 | A6 | A8 | A10 | A12 |
|---|---|---|---|---|---|---|
| 4 | 0.0000 | 7.8520E−05 | 5.3350E−07 | 0.0000E+00 | 0.0000E+00 | 0.0000E+00 |
| 12 | −0.6000 | 1.0780E−03 | 9.9320E−05 | −1.2580E−05 | −5.6970E−06 | 2.2431E−06 |
| 13 | 0.0000 | 2.3770E−02 | −9.6760E−03 | 3.6590E−03 | −8.0630E−04 | 7.6040E−05 |

TABLE 36

| Surface No. | K | A4 | A6 | A8 | A10 | A12 |
|---|---|---|---|---|---|---|
| 4 | 0.0000 | 7.3130E−05 | 4.8300E−07 | 0.0000E+00 | 0.0000E+00 | 0.0000E+00 |
| 12 | −0.6000 | 1.0780E−03 | 9.9320E−05 | −1.2580E−05 | −5.6970E−06 | 2.2431E−06 |
| 13 | 0.0000 | 2.3770E−02 | −9.6760E−03 | 3.6590E−03 | −8.0630E−04 | 7.6040E−05 |

TABLE 37

| Surface No. | K | A4 | A6 | A8 | A10 | A12 |
|---|---|---|---|---|---|---|
| 4 | 0.0000 | 5.0940E−05 | 4.2000E−07 | 0.0000E+00 | 0.0000E+00 | 0.0000E+00 |
| 10 | −0.6000 | 1.0780E−03 | 9.9320E−05 | −1.2580E−05 | −5.6970E−06 | 2.2431E−06 |
| 11 | 0.0000 | 2.3770E−02 | −9.6760E−03 | 3.6590E−03 | −8.0630E−04 | 7.6040E−05 |

Table 38 shows coefficients P₂, . . . of the optical path length difference function defining the phase shift structure formed on the first surface 11 of the objective lens 10 according to the fourth example. Table 39 shows the diffraction order m at which the diffraction efficiency is maximized for each of the first to third laser beams. As shown in FIG. 39, the diffraction order m varies depending on the type of the laser beams.

TABLE 38

| | P2 | P4 | P6 | P8 | P10 | P12 |
|---|---|---|---|---|---|---|
| First Surface | 0.0000E+00 | −7.7370E−01 | −3.5000E−02 | −1.1900E−02 | 0.0000E+00 | 0.0000E+00 |

TABLE 39

| | 1^{st} Laser | 2^{nd} Laser | 3^{rd} Laser |
|---|---|---|---|
| diffraction order m | 3 | 2 | 2 |

As can be seen from the above described Tables, values of the intermediate terms of the conditions (14) and (15) are 0.631, and the value of the intermediate term of the condition (16) is 0.631. Therefore, the objective optical system 30 according to the third example satisfies the conditions (14), (15) and (16).

Table 40 shows a concrete configuration of the phase shift structure formed on the first surface 11 of the objective lens 10. In Table 40, a range of each of annular zones is indicated, numbers are assigned to annular zones in ascending order with respect to the optical axis, and each range of the annular zones is represented by heights hmin and hmax from the optical axis.

TABLE 40

| number | hmin | hmax |
|---|---|---|
| 0 | 0.000 | 0.887 |
| 1 | 0.887 | 1.155 |
| 2 | 1.155 | 1.303 |
| 3 | 1.303 | 1.408 |
| 4 | 1.408 | 1.491 |
| 5 | 1.491 | 1.560 |
| 6 | 1.560 | 1.619 |
| 7 | 1.619 | 1.670 |
| 8 | 1.670 | 1.716 |
| 9 | 1.716 | 1.758 |
| 10 | 1.758 | 1.796 |
| 11 | 1.796 | 1.830 |
| 12 | 1.830 | 1.863 |
| 13 | 1.863 | 1.893 |
| 14 | 1.893 | 1.921 |
| 15 | 1.921 | 1.947 |
| 16 | 1.947 | 1.970 |

As shown in Table 40, the number N of annular zones within the effective diameter of the first surface 11 of the objective lens 10 is 17. In this case, the values of the intermediate terms of the conditions (11) and (12) are 0.830. The value of the intermediate term of the condition (13) is 0.978. Therefore, the objective optical system 30 according to the third example satisfies the conditions (11) to (13). As can be see from Table 31, f1×M1 is 0.000, f2×M2 is 0.000, and f3×M3 is −0.077. Therefore, conditions (7), (8) and (17) are satisfied.

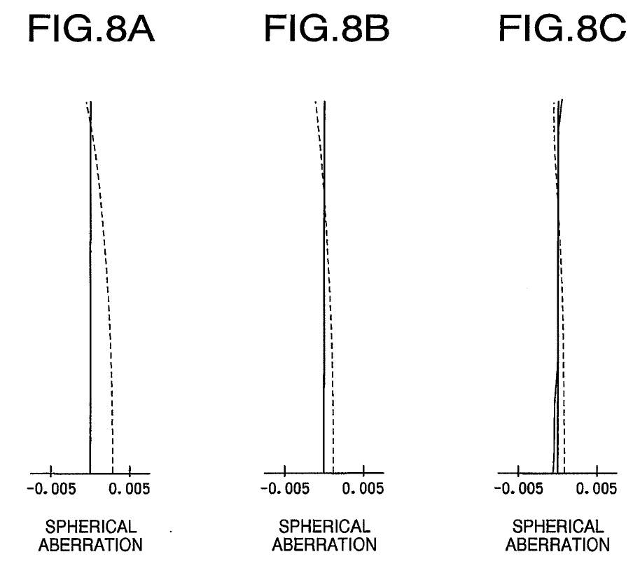

FIG. 8A is a graph illustrating the spherical aberration caused when the first laser beam is used in the optical information recording/reproducing device 100 according to the fourth example. FIG. 8B is a graph illustrating the spherical aberration caused when the second laser beam is used in the optical information recording/reproducing device 100 according to the fourth example. FIG. 8C is a graph illustrating the spherical aberration caused when the third laser beam is used in the optical information recording/reproducing device 100 according to the fourth example.

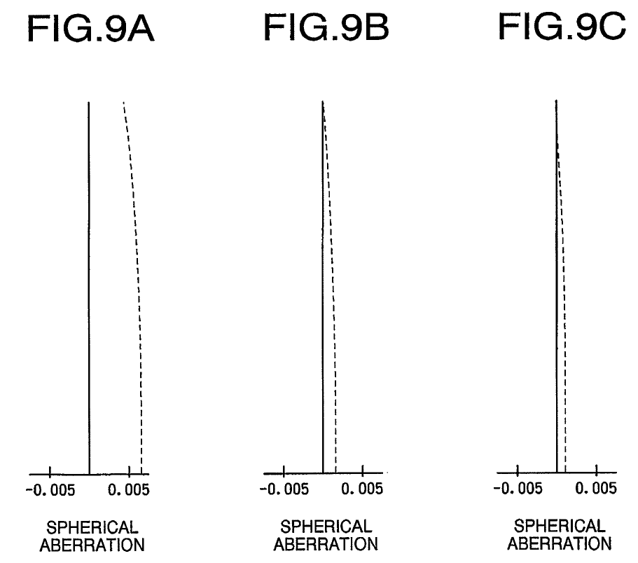

FIGS. 9A, 9B and 9C show spherical aberrations caused in an optical information recording/reproducing device according to the comparative example. FIG. 9A is a graph illustrating the spherical aberration caused when the first laser beam is used in the optical information recording/reproducing device according to the comparative example. FIG. 9B is a graph illustrating the spherical aberration caused when the second laser beam is used in the optical information recording/reproducing device according to the comparative example. FIG. 9C is a graph illustrating the spherical aberration caused when the third laser beam is used in the optical information recording/reproducing device according to the comparative example. As described above. The comparative example is configured such that, in the configuration of the optical information recording/reproducing device 100, the objective optical system 30 is replaced with a single objective lens.

By comparing FIGS. 8A, 8B and 8C with FIGS. 9A, 9B and 9C, it is understood that the optical information recording/reproducing device 100 having the objective optical system 30 is able to suitably correct the longitudinal chromatic aberration for each of the optical discs D1 and D2 in comparison with the comparative example. In addition, the optical information recording/reproducing device 100 is able to suitably correct the spherical aberration for each of the optical discs D1, D2 and D3. That is, the optical information recording/reproducing device 100 is able to form a beam spot suitable for information recording/reproducing of each of the optical discs D1, D2 and D3.

### Fifth Example

The following Table 41 shows concrete specifications of the objective optical system 30 according to a fifth example.

TABLE 41

| | 1^{st} laser beam | 2^{nd} laser beam | 3^{rd} laser beam |
|---|---|---|---|
| Wavelength (nm) | 405 | 660 | 790 |
| Focal Length (mm) | 3.00 | 3.15 | 3.17 |
| NA | 0.65 | 0.60 | 0.47 |
| Magnification M | 0.000 | 0.000 | −0.020 |

As indicated by the “Magnification M” in Table 51, the laser beam is incident upon the chromatic aberration correction element 20 as a collimated beam when each of the optical discs D1 and D2 is used, and the laser beam is incident on the chromatic aberration correction element 20 as a diverging beam when the optical disc D3 is used.

Table 42 shows specific numerical configuration defined when the optical disc D1 is used in the optical information recording/reproducing device 100 provided with the objective optical system 30 shown in Table 41. The following Table 43 shows specific numerical configuration defined when the optical disc D2 is used in the optical information recording/reproducing device 100 provided with the objective optical system 30 shown in Table 41. The following Table 44 shows specific numerical configuration defined when the optical disc D3 is used in the optical information recording/reproducing device 100 provided with the objective optical system 30 shown in Table 41.

TABLE 42

| Surface No. | r | d | n(405 nm) | Comments |
|---|---|---|---|---|
| 0 | | 2.81 | | light source |
| 1 | ∞ | 2.00 | 1.52972 | diffraction grating |
| 2 | ∞ | 13.00 | | |
| 3 | 85.710 | 1.50 | 1.52469 | coupling lens |
| 4 | −10.550 | 1.00 | | |
| 5 | ∞ | 4.00 | 1.52972 | beam splitter |
| 6 | ∞ | 1.00 | | |
| 7 | ∞ | 4.00 | 1.52972 | beam splitter |
| 8 | ∞ | 1.00 | | |
| 9 | ∞ | 1.00 | 1.72925 | chromatic aberration |
| 10 | 4.500 | 1.50 | 1.71793 | correction element |
| 11 | ∞ | 5.03 | | |
| 12 | 1.888 | 2.30 | 1.52469 | objective lens |
| 13 | −6.021 | 1.40 | | |
| 14 | ∞ | 0.60 | 1.62231 | optical disc |
| 15 | ∞ | — | | |

TABLE 43

| Surface No. | r | d | n(660 nm) | Comments |
|---|---|---|---|---|
| 0 | | 2.79 | | light source |
| 1 | ∞ | 2.00 | 1.51374 | diffraction grating |
| 2 | ∞ | 13.00 | | |
| 3 | 101.820 | 1.50 | 1.54044 | coupling lens |
| 4 | −10.700 | 1.00 | | |
| 5 | ∞ | 4.00 | 1.51374 | beam splitter |
| 6 | ∞ | 1.00 | | |
| 7 | ∞ | 4.00 | 1.51374 | beam splitter |
| 8 | ∞ | 1.00 | | |
| 9 | ∞ | 1.00 | 1.68219 | chromatic aberration |
| 10 | 4.500 | 1.50 | 1.69280 | correction element |
| 11 | ∞ | 5.00 | | |
| 12 | 1.888 | 2.30 | 1.50635 | objective lens |
| 13 | −6.021 | 1.43 | | |
| 14 | ∞ | 0.60 | 1.57961 | optical disc |
| 15 | ∞ | — | | |

TABLE 44

| Surface No. | r | d | n(790 nm) | Comments |
|---|---|---|---|---|
| 0 | | 2.84 | | light source |
| 1 | ∞ | 2.00 | 1.51052 | diffraction grating |
| 2 | ∞ | 12.00 | | |
| 3 | −560.000 | 1.50 | 1.53653 | coupling lens |
| 4 | −10.280 | 7.48 | | |
| 5 | ∞ | 4.00 | 1.51052 | beam splitter |
| 6 | ∞ | 1.00 | | |
| 7 | ∞ | 1.00 | 1.67450 | chromatic aberration |
| 8 | 4.500 | 1.50 | 1.68790 | correction element |
| 9 | ∞ | 5.32 | | |
| 10 | 1.888 | 2.30 | 1.50313 | objective lens |
| 11 | −6.021 | 1.11 | | |
| 12 | ∞ | 1.20 | 1.57307 | optical disc |
| 13 | ∞ | — | | |

A second surface of each of the coupling lenses 3A, 3B and 3C, and the first surface 11 and the second surface 12 of the objective lens 10 are aspherical surfaces. The following Table 45 shows the cone constant and aspherical coefficients specifying the shape of each aspherical surface when the optical disc D1 is used. The following Table 46 shows the cone constant and aspherical coefficients specifying the shape of each aspherical surface when the optical disc D2 is used. The following Table 47 shows the cone constant and aspherical coefficients specifying the shape of each aspherical surface when the optical disc D3 is used.

TABLE 45

| Surface No. | K | A4 | A6 | A8 | A10 | A12 |
|---|---|---|---|---|---|---|
| 4 | 0.0000 | 7.8520E−05 | 5.3350E−07 | 0.0000E+00 | 0.0000E+00 | 0.0000E+00 |
| 12 | −0.6000 | 7.1680E−04 | 3.4000E−06 | −1.8300E−05 | −2.9960E−05 | 7.3600E−06 |
| 13 | 0.0000 | 3.6260E−02 | −1.7110E−02 | 6.6490E−03 | −1.4090E−03 | 1.2555E−04 |

TABLE 46

| Surface No. | K | A4 | A6 | A8 | A10 | A12 |
|---|---|---|---|---|---|---|
| 4 | 0.0000 | 7.3130E−05 | 4.8300E−07 | 0.0000E+00 | 0.0000E+00 | 0.0000E+00 |
| 12 | −0.6000 | 7.1680E−04 | 3.4000E−06 | −1.8300E−05 | −2.9960E−05 | 7.3600E−06 |
| 13 | 0.0000 | 3.6260E−02 | −1.7110E−02 | 6.6490E−03 | −1.4090E−03 | 1.2555E−04 |

TABLE 47

| Surface No. | K | A4 | A6 | A8 | A10 | A12 |
|---|---|---|---|---|---|---|
| 4 | 0.0000 | 5.5700E−05 | 4.4000E−07 | 3.1000E−09 | 0.0000E+00 | 0.0000E+00 |
| 10 | −0.6000 | 7.1680E−04 | 3.4000E−06 | −1.8300E−05 | −2.9960E−05 | 7.3600E−06 |
| 11 | 0.0000 | 3.6260E−02 | −1.7110E−02 | 6.6490E−03 | −1.4090E−03 | 1.2555E−04 |

Table 48 shows coefficients P₂, . . . of the optical path length difference function defining the phase shift structure formed on the first surface 11 of the objective lens 10 according to the fifth example. Table 49 shows the diffraction order m at which the diffraction efficiency is maximized for each of the first to third laser beams. As shown in FIG. 49, the diffraction order m varies depending on the type of the laser beams.

TABLE 48

| | P2 | P4 | P6 | P8 | P10 | P12 |
|---|---|---|---|---|---|---|
| First Surface | −1.0000E+00 | −8.6800E−01 | −3.9500E−02 | −1.3820E−02 | 0.0000E+00 | 0.0000E+00 |

TABLE 49

| | 1^{st} Laser | 2^{nd} Laser | 3^{rd} Laser |
|---|---|---|---|
| diffraction order m | 3 | 2 | 2 |

As can be seen from the above described Tables, values of the intermediate terms of the conditions (14) and (15) are 0.833. Therefore, the objective optical system 30 according to the fifth example satisfies the conditions (14) and (15).

Table 50 shows a concrete configuration of the phase shift structure formed on the first surface 11 of the objective lens 10. In Table 50, a range of each of annular zones is indicated, numbers are assigned to annular zones in ascending order with respect to the optical axis, and each range of the annular zones is represented by heights hmin and hmax from the optical axis.

TABLE 50

| number | hmin | hmax |
|---|---|---|
| 0 | 0.000 | 0.613 |
| 1 | 0.613 | 0.920 |
| 2 | 0.920 | 1.089 |
| 3 | 1.089 | 1.209 |
| 4 | 1.209 | 1.302 |
| 5 | 1.302 | 1.380 |
| 6 | 1.380 | 1.445 |
| 7 | 1.445 | 1.503 |
| 8 | 1.503 | 1.554 |
| 9 | 1.554 | 1.600 |
| 10 | 1.600 | 1.642 |
| 11 | 1.642 | 1.680 |
| 12 | 1.680 | 1.715 |
| 13 | 1.715 | 1.748 |
| 14 | 1.748 | 1.779 |
| 15 | 1.779 | 1.808 |
| 16 | 1.808 | 1.835 |
| 17 | 1.835 | 1.861 |
| 18 | 1.861 | 1.885 |
| 19 | 1.885 | 1.909 |
| 20 | 1.909 | 1.931 |
| 21 | 1.931 | 1.952 |
| 22 | 1.952 | 1.980 |

As shown in Table 50, the number N of annular zones within the effective diameter of the first surface 11 of the objective lens 10 is 23. In this case, the values of the intermediate terms of the conditions (11) and (12) are 1.017. Therefore, the objective optical system 30 according to the fifth example satisfies the conditions (11) and (12). As can be see from Table 41, f1×M1 is 0.000, f2×M2 is 0.000, and f3×M3 is −0.063. Therefore, conditions (7), (8) and (17) are satisfied. As can be seen from tables 42 and 43, the value of (nB1−nB2)/(nR1−nR2) is −1.067. Therefore, condition (10) is satisfied.

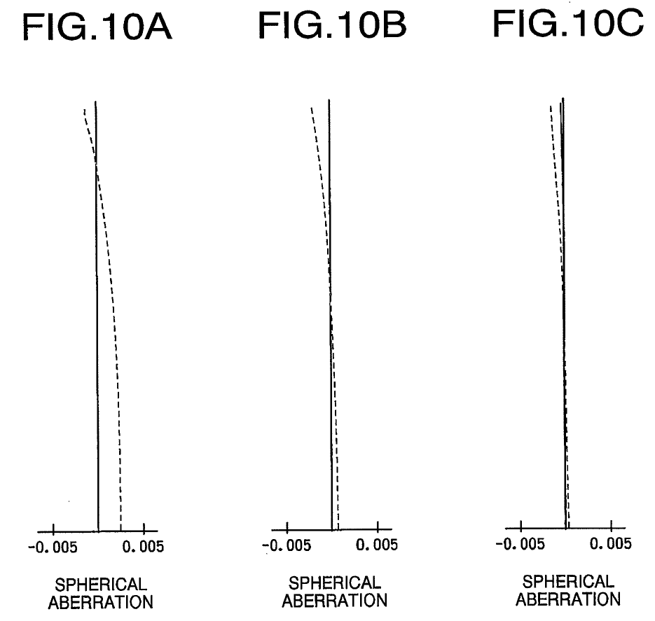

FIG. 10A is a graph illustrating the spherical aberration caused when the first laser beam is used in the optical information recording/reproducing device 100 according to the fifth example. FIG. 10B is a graph illustrating the spherical aberration caused when the second laser beam is used in the optical information recording/reproducing device 100 according to the fifth example. FIG. 10C is a graph illustrating the spherical aberration caused when the third laser beam is used in the optical information recording/reproducing device 100 according to the fifth example.

As shown in FIGS. 10A, 10B and 10C, it is understood that the optical information recording/reproducing device 100 having the objective optical system 30 is able to suitably correct the longitudinal chromatic aberration for each of the optical discs D1 and D2. In addition, the optical information recording/reproducing device 100 is able to suitably correct the spherical aberration for each of the optical discs D1, D2 and D3. That is, the optical information recording/reproducing device 100 is able to form a beam spot suitable for information recording/reproducing of each of the optical discs D1, D2 and D3.

### Sixth Example

The following Table 51 shows concrete specifications of the objective optical system 30 according to a sixth example.

TABLE 51

| | 1^{st} laser beam | 2^{nd} laser beam | 3^{rd} laser beam |
|---|---|---|---|
| Wavelength (nm) | 405 | 660 | 790 |
| Focal Length (mm) | 2.30 | 2.43 | 2.45 |
| NA | 0.65 | 0.65 | 0.47 |
| Magnification M | 0.000 | 0.000 | −0.073 |

As indicated by the “Magnification M” in Table 51, the laser beam is incident upon the chromatic aberration correction element 20 as a collimated beam when each of the optical discs D1 and D2 is used, and the laser beam is incident on the chromatic aberration correction element 20 as a diverging beam when the optical disc D3 is used.

Table 52 shows specific numerical configuration defined when the optical disc D1 is used in the optical information recording/reproducing device 100 provided with the objective optical system 30 shown in Table 51. The following Table 53 shows specific numerical configuration defined when the optical disc D2 is used in the optical information recording/reproducing device 100 provided with the objective optical system 30 shown in Table 51. The following Table 54 shows specific numerical configuration defined when the optical disc D3 is used in the optical information recording/reproducing device 100 provided with the objective optical system 30 shown in Table 51.

TABLE 52

| Surface No. | r | d | n(405 nm) | Comments |
|---|---|---|---|---|
| 0 | | 2.81 | | light source |
| 1 | ∞ | 2.00 | 1.52972 | diffraction grating |
| 2 | ∞ | 13.00 | | |
| 3 | 85.710 | 1.50 | 1.52469 | coupling lens |
| 4 | −10.550 | 1.00 | | |
| 5 | ∞ | 3.20 | 1.52972 | beam splitter |
| 6 | ∞ | 1.00 | | |
| 7 | ∞ | 3.20 | 1.52972 | beam splitter |
| 8 | ∞ | 1.00 | | |
| 9 | ∞ | 1.00 | 1.82201 | chromatic aberration |
| 10 | 2.000 | 2.00 | 1.81656 | correction element |
| 11 | ∞ | 5.02 | | |
| 12 | 1.500 | 1.75 | 1.52469 | objective lens |
| 13 | −4.189 | 1.02 | | |
| 14 | ∞ | 0.60 | 1.62231 | optical disc |
| 15 | ∞ | — | | |

TABLE 53

| Surface No. | r | d | n(660 nm) | Comments |
|---|---|---|---|---|
| 0 | | 2.79 | | light source |
| 1 | ∞ | 2.00 | 1.51374 | diffraction grating |
| 2 | ∞ | 13.00 | | |
| 3 | 101.820 | 1.50 | 1.54044 | coupling lens |
| 4 | −10.700 | 1.00 | | |
| 5 | ∞ | 3.20 | 1.51374 | beam splitter |
| 6 | ∞ | 1.00 | | |
| 7 | ∞ | 3.20 | 1.51374 | beam splitter |
| 8 | ∞ | 1.00 | | |
| 9 | ∞ | 1.00 | 1.77637 | chromatic aberration |
| 10 | 2.000 | 2.00 | 1.78277 | correction element |
| 11 | ∞ | 5.00 | | |
| 12 | 1.500 | 1.75 | 1.50635 | objective lens |
| 13 | −4.189 | 1.04 | | |
| 14 | ∞ | 0.60 | 1.57961 | optical disc |
| 15 | ∞ | — | | |

TABLE 54

| Surface No. | r | d | n(790 nm) | Comments |
|---|---|---|---|---|
| 0 | | 2.21 | | light source |
| 1 | ∞ | 2.00 | 1.51052 | diffraction grating |
| 2 | ∞ | 4.00 | | |
| 3 | −14.524 | 1.50 | 1.53653 | coupling lens |
| 4 | −5.590 | 5.48 | | |
| 5 | ∞ | 3.20 | 1.51052 | beam splitter |
| 6 | ∞ | 1.00 | | |
| 7 | ∞ | 1.00 | 1.76870 | chromatic aberration |
| 8 | 2.000 | 2.00 | 1.77651 | correction element |
| 9 | ∞ | 5.20 | | |
| 10 | 1.500 | 1.75 | 1.50313 | objective lens |
| 11 | −4.189 | 0.84 | | |
| 12 | ∞ | 1.20 | 1.57307 | optical disc |
| 13 | ∞ | — | | |

A second surface of each of the coupling lenses 3A, 3B and 3C, and the first surface 11 and the second surface 12 of the objective lens 10 are aspherical surfaces. The following Table 55 shows the cone constant and aspherical coefficients specifying the shape of each aspherical surface when the optical disc D1 is used. The following Table 56 shows the cone constant and aspherical coefficients specifying the shape of each aspherical surface when the optical disc D2 is used. The following Table 57 shows the cone constant and aspherical coefficients specifying the shape of each aspherical surface when the optical disc D3 is used.

TABLE 55

| Surface No. | K | A4 | A6 | A8 | A10 | A12 |
|---|---|---|---|---|---|---|
| 4 | 0.0000 | 7.8520E−05 | 5.3350E−07 | 0.0000E+00 | 0.0000E+00 | 0.0000E+00 |
| 12 | −0.6000 | 7.9130E−04 | 5.1920E−04 | 3.1570E−04 | 6.4850E−05 | −2.8840E−05 |
| 13 | 0.0000 | 5.5270E−02 | −1.1180E−02 | −2.1890E−03 | 1.8280E−03 | −3.1600E−04 |

TABLE 56

| Surface No. | K | A4 | A6 | A8 | A10 | A12 |
|---|---|---|---|---|---|---|
| 4 | 0.0000 | 7.3130E−05 | 4.8300E−07 | 0.0000E+00 | 0.0000E+00 | 0.0000E+00 |
| 12 | −0.6000 | 7.9130E−04 | 5.1920E−04 | 3.1570E−04 | 6.4850E−05 | −2.8840E−05 |
| 13 | 0.0000 | 5.5270E−02 | −1.1180E−02 | −2.1890E−03 | 1.8280E−03 | −3.1600E−04 |

TABLE 57

| Surface No. | K | A4 | A6 | A8 | A10 | A12 |
|---|---|---|---|---|---|---|
| 4 | 0.0000 | 4.9260E−05 | 1.6160E−06 | 4.6940E−08 | 1.7480E−09 | 0.0000E+00 |
| 10 | −0.6000 | 7.9130E−04 | 5.1920E−04 | 3.1570E−04 | 6.4850E−05 | −2.8840E−05 |
| 11 | 0.0000 | 5.5270E−02 | −1.1180E−02 | −2.1890E−03 | 1.8280E−03 | −3.1600E−04 |

Table 58 shows coefficients P₂, . . . of the optical path length difference function defining the phase shift structure formed on the first surface 11 of the objective lens 10 according to the sixth example. Table 59 shows the diffraction order m at which the diffraction efficiency is maximized for each of the first to third laser beams. As shown in FIG. 59, the diffraction order m varies depending on the type of the laser beams.

TABLE 58

| | P2 | P4 | P6 | P8 | P10 | P12 |
|---|---|---|---|---|---|---|
| First Surface | −2.5000E+00 | −9.0000E−01 | −1.7780E−01 | 1.5460E−02 | 0.0000E+00 | 0.0000E+00 |

TABLE 59

| | 1^{st} Laser | 2^{nd} Laser | 3^{rd} Laser |
|---|---|---|---|
| diffraction order m | 3 | 2 | 2 |

As can be seen from the above described Tables, values of the intermediate terms of the conditions (14) and (15) are 0.792, and the value of the intermediate term of the condition (16) is 0.840. Therefore, the objective optical system 30 according to the sixth example satisfies the conditions (14), (15) and (16).

Table 60 shows a concrete configuration of the phase shift structure formed on the first surface 11 of the objective lens 10. In Table 60, a range of each of annular zones is indicated, numbers are assigned to annular zones in ascending order with respect to the optical axis, and each range of the annular zones is represented by heights hmin and hmax from the optical axis.

TABLE 60

| number | hmin | hmax |
|---|---|---|
| 0 | 0.000 | 0.432 |
| 1 | 0.432 | 0.708 |
| 2 | 0.708 | 0.873 |
| 3 | 0.873 | 0.993 |
| 4 | 0.993 | 1.089 |
| 5 | 1.089 | 1.169 |
| 6 | 1.169 | 1.238 |
| 7 | 1.238 | 1.298 |
| 8 | 1.298 | 1.353 |
| 9 | 1.353 | 1.401 |
| 10 | 1.401 | 1.446 |
| 11 | 1.446 | 1.488 |
| 12 | 1.488 | 1.530 |

As shown in Table 60, the number N of annular zones within the effective diameter of the first surface 11 of the objective lens 10 is 13. In this case, the values of the intermediate terms of the conditions (11) and (12) are 0.810, and the value of the intermediate term of the condition (13) is 0.861. Therefore, the objective optical system 30 according to the sixth example satisfies the conditions (11), (12) and (13). As can be see from Table 51, f1×M1 is 0.000, f2×M2 is 0.000, and f3×M3 is −0.179. Therefore, conditions (7), (8) and (17) are satisfied. As can be seen from tables 52 and 53, the value of (nB1−nB2)/(nR1−nR2) is −0.852. Therefore, condition (10) is satisfied.

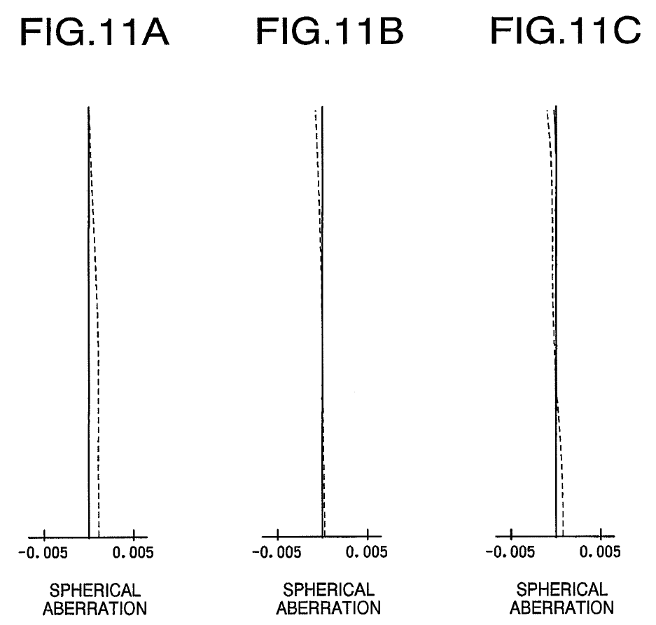

FIG. 11A is a graph illustrating the spherical aberration caused when the first laser beam is used in the optical information recording/reproducing device 100 according to the sixth example. FIG. 11B is a graph illustrating the spherical aberration caused when the second laser beam is used in the optical information recording/reproducing device 100 according to the sixth example. FIG. 11C is a graph illustrating the spherical aberration caused when the third laser beam is used in the optical information recording/reproducing device 100 according to the sixth example.

As shown in FIGS. 11A, 11B and 11C, it is understood that the optical information recording/reproducing device 100 having the objective optical system 30 is able to suitably correct the longitudinal chromatic aberration for each of the optical discs D1 and D2. In addition, the optical information recording/reproducing device 100 is able to suitably correct the spherical aberration for each of the optical discs D1, D2 and D3. That is, the optical information recording/reproducing device 100 is able to form a beam spot suitable for information recording/reproducing of each of the optical discs D1, D2 and D3.

### Seventh Example

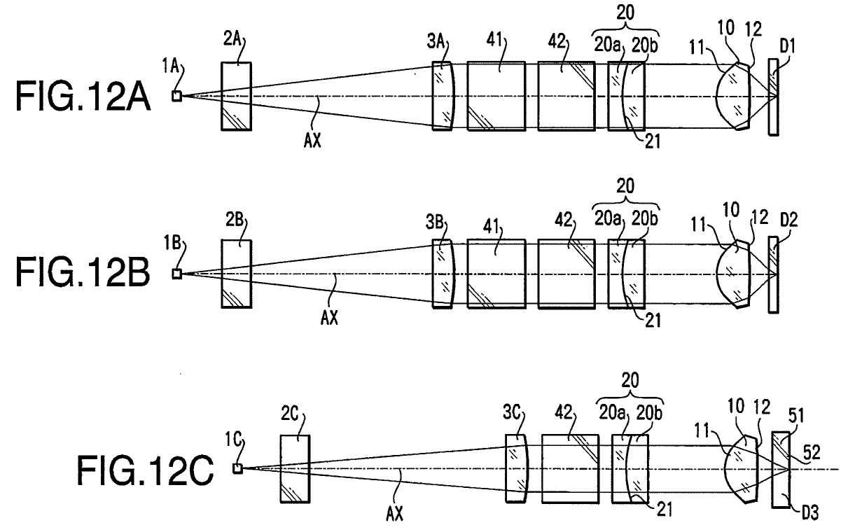

FIGS. 12A, 12B and 12C respectively show optical block diagrams of the optical information recording/reproducing device 100 according to a seventh example along optical paths for the first to third laser beams. FIGS. 12A, 12B and 12C respectively correspond to FIGS. 2A, 2B and 2C. In FIGS. 12A-12C, to elements that are substantially the same as those shown in FIGS. 2A-2C, the same reference numbers are assigned. The following Table 61 shows concrete specifications of the objective optical system 30 according to the seventh example.

TABLE 61

| | 1^{st} laser beam | 2^{nd} laser beam | 3^{rd} laser beam |
|---|---|---|---|
| Wavelength (nm) | 405 | 660 | 790 |
| Focal Length (mm) | 3.00 | 3.14 | 3.17 |
| NA | 0.65 | 0.60 | 0.47 |
| Magnification M | 0.000 | 0.000 | 0.000 |

As indicated by the “Magnification M” in Table 61, the all of the first to third beams are incident on the chromatic aberration correction element 20 as collimated beams.

Table 62 shows specific numerical configuration defined when the optical disc D1 is used in the optical information recording/reproducing device 100 provided with the objective optical system 30 shown in Table 61. The following Table 63 shows specific numerical configuration defined when the optical disc D2 is used in the optical information recording/reproducing device 100 provided with the objective optical system 30 shown in Table 61. The following Table 64 shows specific numerical configuration defined when the optical disc D3 is used in the optical information recording/reproducing device 100 provided with the objective optical system 30 shown in Table 61.

TABLE 62

| Surface No. | r | d | n(405 nm) | Comments |
|---|---|---|---|---|
| 0 | | 2.81 | | light source |
| 1 | ∞ | 2.00 | 1.52972 | diffraction grating |
| 2 | ∞ | 13.00 | | |
| 3 | 85.710 | 1.50 | 1.52469 | coupling lens |
| 4 | −10.550 | 1.00 | | |
| 5 | ∞ | 4.00 | 1.52972 | beam splitter |
| 6 | ∞ | 1.00 | | |
| 7 | ∞ | 4.00 | 1.52972 | beam splitter |
| 8 | ∞ | 1.00 | | |
| 9 | ∞ | 1.00 | 1.81566 | chromatic aberration |
| 10 | 7.000 | 1.50 | 1.81656 | correction element |
| 11 | ∞ | 5.04 | | |
| 12 | 1.839 | 2.30 | 1.52469 | objective lens |
| 13 | −6.206 | 1.34 | | |
| 14 | ∞ | 0.60 | 1.62231 | optical disc |
| 15 | ∞ | — | | |

TABLE 63

| Surface No. | r | d | n(660 nm) | Comments |
|---|---|---|---|---|
| 0 | | 2.79 | | light source |
| 1 | ∞ | 2.00 | 1.51374 | diffraction grating |
| 2 | ∞ | 13.00 | | |
| 3 | 101.820 | 1.50 | 1.54044 | coupling lens |
| 4 | −10.700 | 1.00 | | |
| 5 | ∞ | 4.00 | 1.51374 | beam splitter |
| 6 | ∞ | 1.00 | | |
| 7 | ∞ | 4.00 | 1.51374 | beam splitter |
| 8 | ∞ | 1.00 | | |
| 9 | ∞ | 1.00 | 1.75320 | chromatic aberration |
| 10 | 7.000 | 1.50 | 1.78277 | correction element |
| 11 | ∞ | 5.00 | | |
| 12 | 1.839 | 2.30 | 1.50635 | objective lens |
| 13 | −6.206 | 1.38 | | |
| 14 | ∞ | 0.60 | 1.57961 | optical disc |
| 15 | ∞ | — | | |

TABLE 64

| Surface No. | r | d | n(790 nm) | Comments |
|---|---|---|---|---|
| 0 | | 2.79 | | light source |
| 1 | ∞ | 2.00 | 1.51052 | diffraction grating |
| 2 | ∞ | 14.00 | | |
| 3 | 102.700 | 1.50 | 1.53653 | coupling lens |
| 4 | −11.260 | 1.00 | | |
| 5 | ∞ | 4.00 | 1.51052 | beam splitter |
| 6 | ∞ | 1.00 | | |
| 7 | ∞ | 1.00 | 1.74345 | chromatic aberration |
| 8 | 7.000 | 1.50 | 1.77651 | correction element |
| 9 | ∞ | 5.38 | | |
| 10 | 1.839 | 2.30 | 1.50313 | objective lens |
| 11 | −6.206 | 1.00 | | |
| 12 | ∞ | 1.20 | 1.57307 | optical disc |
| 13 | ∞ | — | | |

A second surface of each of the coupling lenses 3A, 3B and 3C, and the first surface 11 and the second surface 12 of the objective lens 10 are aspherical surfaces. The following Table 65 shows the cone constant and aspherical coefficients specifying the shape of each aspherical surface when the optical disc D1 is used. The following Table 66 shows the cone constant and aspherical coefficients specifying the shape of each aspherical surface when the optical disc D2 is used. The following Table 67 shows the cone constant and aspherical coefficients specifying the shape of each aspherical surface when the optical disc D3 is used.

TABLE 65

| Surface No. | K | A4 | A6 | A8 | A10 | A12 |
|---|---|---|---|---|---|---|
| 4 | 0.0000 | 7.8520E−05 | 5.3350E−07 | 0.0000E+00 | 0.0000E+00 | 0.0000E+00 |
| 12 | −0.6000 | −8.2100E−04 | 7.0500E−05 | −2.5050E−05 | 1.8550E−06 | −9.5930E−07 |
| 13 | 0.0000 | 3.1670E−02 | −7.6060E−03 | 1.2740E−03 | −1.1840E−04 | 3.8600E−06 |

TABLE 66

| Surface No. | K | A4 | A6 | A8 | A10 | A12 |
|---|---|---|---|---|---|---|
| 4 | 0.0000 | 7.3130E−05 | 4.8300E−07 | 0.0000E+00 | 0.0000E+00 | 0.0000E+00 |
| 12 | −0.6000 | −8.2100E−04 | 7.0500E−05 | −2.5050E−05 | 1.8550E−06 | −9.5930E−07 |
| 13 | 0.0000 | 3.1670E−02 | −7.6060E−03 | 1.2740E−03 | −1.1840E−04 | 3.8600E−06 |

TABLE 67

| Surface No. | K | A4 | A6 | A8 | A10 | A12 |
|---|---|---|---|---|---|---|
| 4 | 0.0000 | 6.3400E−05 | 3.8200E−07 | 0.0000E+00 | 0.0000E+00 | 0.0000E+00 |
| 10 | −0.6000 | −8.2100E−04 | 7.0500E−05 | −2.5050E−05 | 1.8550E−06 | −9.5930E−07 |
| 11 | 0.0000 | 3.1670E−02 | −7.6060E−03 | 1.2740E−03 | −1.1840E−04 | 3.8600E−06 |

As described above, in this example the collimated beam is used for all of the optical discs D1-D3. For this reason, the phase shift structure formed on the first surface 11 of the objective lens 10 according to the seventh example is defined by the two types of optical path length difference functions (first and second optical path length difference functions). Table 68 shows coefficients P₂, . . . of the first and second optical path length difference functions defining the phase shift structure formed on the first surface 11 of the objective lens 10. Table 69 shows the diffraction order m at which the diffraction efficiency is maximized for each of the first to third laser beams. In Table 69, the diffractions orders are shown for each of the first and second optical path length difference functions (OPLD). As shown in FIG. 69, the diffraction order m varies depending on the type of the laser beams.

TABLE 68

| | P2 | P4 | P6 | P8 | P10 | P12 |
|---|---|---|---|---|---|---|
| 1st OPLD | 0.0000E+00 | −1.1290E+00 | −7.8400E−02 | −1.5420E−02 | 0.0000E+00 | 0.0000E+00 |
| Function(i = 1) | | | | | | |
| 2nd OPLD | 0.0000E+00 | −2.9260E−01 | −1.3400E−02 | −6.9700E−03 | 0.0000E+00 | 0.0000E+00 |
| Function(i = 2) | | | | | | |

TABLE 69

| | 1^{st} Laser | 2^{nd} Laser | 3^{rd} Laser |
|---|---|---|---|
| 1st OPLD function | 3 | 2 | 2 |
| (i = 1) | | | |
| 2nd OPLD function | 2 | 1 | 1 |
| (i = 2) | | | |

As can be seen from the above described Tables, values of the intermediate terms of the conditions (14) and (15) are 0.670, and the value of the intermediate term of the condition (16) is 0.670. Therefore, the objective optical system 30 according to the seventh example satisfies the conditions (14), (15) and (16).

FIG. 13A is a graph illustrating the spherical aberration caused when the first laser beam is used in the optical information recording/reproducing device 100 according to the seventh example. FIG. 13B is a graph illustrating the spherical aberration caused when the second laser beam is used in the optical information recording/reproducing device 100 according to the seventh example. FIG. 13C is a graph illustrating the spherical aberration caused when the third laser beam is used in the optical information recording/reproducing device 100 according to the seventh example.

As shown in FIGS. 13A, 13B and 13C, it is understood that the optical information recording/reproducing device 100 having the objective optical system 30 is able to suitably correct the longitudinal chromatic aberration for each of the optical discs D1 and D2. In addition, the optical information recording/reproducing device 100 is able to suitably correct the spherical aberration for each of the optical discs D1, D2 and D3. That is, the optical information recording/reproducing device 100 is able to form a beam spot suitable for information recording/reproducing of each of the optical discs D1, D2 and D3.

Although the present invention has been described in considerable detail with reference to certain preferred embodiments thereof, other embodiments are possible.

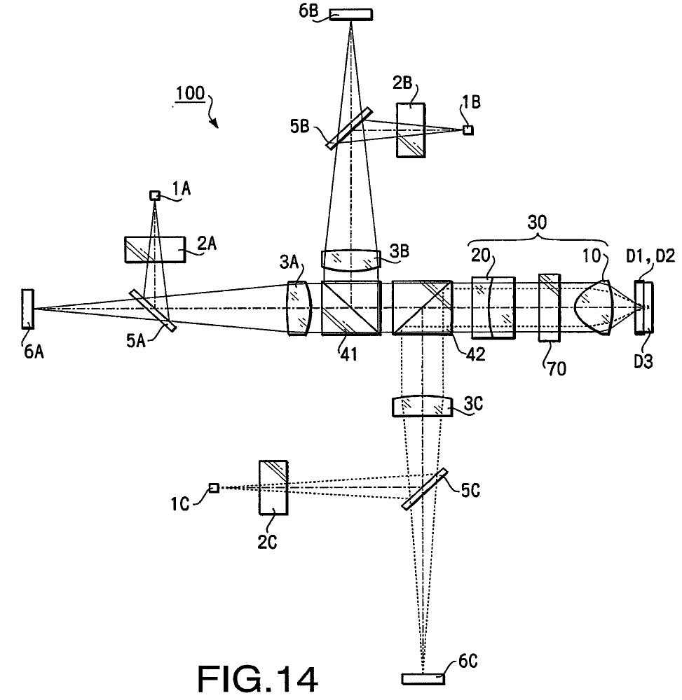

In the above mention embodiment, a phase shift surface (i.e., a diffracting surface) is formed on one of the surfaces of the objective lens 10. However, the phase shift surface may be formed on another optical element (i.e., an element other than the objective lens 10). In this case, the optical element on which the phase shift surface is formed is located on a light source side with respect to the objective lens 10. FIG. 14 shows this configuration. In FIG. 14, to elements that are substantially the same as those shown in FIG. 1, the same reference numbers are assigned. As shown in FIG. 14, an optical element 70 on which the phase shift structure is formed is located on the light source side with respect to the objective lens 10.

In the above mentioned embodiment, the optical information recording/reproducing device and the objective optical system are configured to have the compatibility with the three types of optical discs. However, it is understood that the present invention can also be applied to an optical information recording/reproducing device and an objective optical system having the compatibility with the two types of optical discs (e.g., the optical discs D1 and D2).

This application claims priority of Japanese Patent Applications No. P2006-327188, filed on Dec. 4, 2006, and No. P2007-041316, filed on Feb. 21, 2007. The entire subject matter of the applications is incorporated herein by reference.

What is claimed is:

1. An objective optical system used for an optical information recording/reproducing device for recording information to and/or reproducing information from at least two types of optical discs including a first optical disc and a second optical disc having a recording density lower than that of the first optical disc, by selectively using one of two types light beams including a first light beam having a first wavelength λ₁ and a second light beam having a second wavelength λ₂ larger than the first wavelength λ₁, comprising:
a chromatic aberration correction element including a first lens having a negative power and a second lens having a positive power, materials of the first lens and the second lens being different from each other, the first lens and the second lens being cemented together via a cementing surface to correct a longitudinal chromatic aberration;
at least one phase shift surface configured to have a plurality of annular refractive surface zones concentrically formed about a reference axis of the at least one phase shift surface and to have a step formed between adjacent ones of the plurality of annular refractive surface zones to give a predetermined optical path length difference to the first light beam; and
an objective lens,
wherein each of the chromatic aberration correction element and the at least one phase shift surface is located along an optical path common to the first and second light beams, and
wherein the chromatic aberration correction element is located on a light source side with respect to the objective lens.

2. The objective optical system according to claim 1, wherein:
the predetermined optical path length difference given by the step of the at least one phase shift surface to the first light beam is approximately equal to 2λ₁; and
the objective optical system satisfies a condition:
$$0.44 < \frac{\{ ( nB 1 - nB 2 ) - ( nR 1 - nR 2 ) \} \{ ( f 1 / R ) + 0.008 N \}}{nB 3 - nR 3} < 2.00 \qquad ( 1 )$$
where N represents the number of annular zones, nB1 represents a refractive index of the first lens at the first wavelength λ₁, nB2 represents a refractive index of the second lens at the first wavelength λ₁, nR1 represents a refractive index of the first lens at the second wavelength λ₂, nR2 represents a refractive index of the second lens at second wavelength λ₂, R represents a radius of curvature of the cementing surface of the chromatic aberration correction element, and f1 represents a total focal length at the first wavelength λ₁, nB3 represents a refractive index of the objective lens at the first wavelength λ₁, and nR3 represents the refractive index of the objective lens at second wavelength λ₂.

3. The objective optical system according to claim 2,
wherein the objective optical system satisfies a condition:
$$0.74 < \frac{\{ ( nB 1 - nB 2 ) - ( nR 1 - nR 2 ) \} \{ ( f 1 / R ) + 0.008 N \}}{nB 3 - nR 3} < 1.70 . \qquad ( 2 )$$

4. The objective optical system according to claim 2,
wherein the objective optical system satisfies a condition:
$$0.95 < \frac{\{ ( nB 1 - nB 2 ) - ( nR 1 - nR 2 ) \} \{ ( f 1 / R ) + 0.014 N \}}{nB 3 - nR 3} < 2.19 . \qquad ( 3 )$$

5. The objective optical system according to claim 1, wherein:
the predetermined optical path length difference given by the step of the at least one phase shift surface to the first light beam is approximately equal to 3λ₁; and
the objective optical system satisfies a condition:
$$0.43 < \frac{\{ ( nB 1 - nB 2 ) - ( nR 1 - nR 2 ) \} \{ ( f 1 / R ) + 0.008 N \}}{nB 3 - nR 3} < 1.38 \qquad ( 11 )$$
where N represents the number of annular zones, nB1 represents a refractive index of the first lens at the first wavelength λ₁, nB2 represents a refractive index of the second lens at the first wavelength λ₁, nR1 represents a refractive index of the first lens at the second wavelength λ₂, nR2 represents a refractive index of the second lens at second wavelength λ₂, R represents a radius of curvature of the cementing surface of the chromatic aberration correction element, and f1 represents a total focal length at the first wavelength λ₁, nB3 represents a refractive index of the objective lens at the first wavelength λ₁, and nR3 represents the refractive index of the objective lens at second wavelength λ₂.

6. The objective optical system according to claim 5,
wherein the objective optical system satisfies a condition:
$$0.68 < \frac{\{ ( nB 1 - nB 2 ) - ( nR 1 - nR 2 ) \} \{ ( f 1 / R ) + 0.008 N \}}{nB 3 - nR 3} < 1.13 . \qquad ( 12 )$$

7. The objective optical system according to claim 5,
wherein the objective optical system satisfies a condition:
$$0.80 < \frac{\{ ( nB 1 - nB 2 ) - ( nR 1 - nR 2 ) \} \{ ( f 1 / R ) + 0.014 N \}}{nB 3 - nR 3} < 1.13 . \qquad ( 13 )$$

8. The objective optical system according to claim 1, further comprising an optical element on which the at least one phase shift surface is formed.

9. The objective optical system according to claim 1, wherein the at east one phase shift surface is formed on at least one of surfaces of the objective lens.

10. The objective optical system according to claim 1, wherein:
the first lens of the chromatic aberration correction element includes a planoconcave lens;
the second lens of the chromatic aberration correction element includes a planoconvex lens; and
the chromatic aberration correction element is configured such that curved surfaces of the first lens and the second lens form the cementing surface.

11. An objective optical system used for an optical information recording/reproducing device for recording information to and/or reproducing information from at least two types of optical discs including a first optical disc and a second optical disc having a recording density lower than that of the first optical disc, by selectively using one of two types light beams including a first light beam having a first wavelength and a second light beam having a second wavelength larger than the first wavelength, comprising:
a chromatic aberration correction element including a first lens having a negative power and a second lens having a positive power, materials of the first lens and the second lens being different from each other, the first lens and the second lens being cemented together via a cementing surface to correct a longitudinal chromatic aberration;
at least one diffracting surface; and
an objective lens,
wherein:
the at least one diffracting surface is represented by an optical path length difference function φi(h) (where i is an integer):
φ(h)=(Pᵢ₂h²+Pᵢ₄h⁴+Pᵢ₆h⁶+Pᵢ₈h⁸+Pᵢ₁₀h¹⁰+Pᵢ₁₂h¹²)mᵢλ
where Pᵢ₂, Pᵢ₄, Pᵢ₆ . . . represents 2-th, 4-th, 6-th . . . coefficients, mᵢ represents a diffraction order at which diffraction efficiency of an incident light beam incident on the at least one diffracting surface is maximized, and λ represents a design wavelength of the incident light beam;
each of the chromatic aberration correction element and the at least one diffracting surface is located along an optical path common to the first and second light beams; and
the chromatic aberration correction element is located on a light source side with respect to the objective lens.

12. The objective optical system according to claim 11,
wherein the at least one diffracting surface is configured such that a diffraction order at which the diffraction efficiency for the first light beam is maximized is a second order, and
wherein the objective optical system satisfies a condition:
$$0.55 < \frac{\{ ( nB 1 - nB 2 ) - ( nR 1 - nR 2 ) \} \{ ( f 1 / R ) - 0.03 {P}_{12} \}}{nB 3 - nR 3} < 1.65 \qquad ( 4 )$$
where N represents the number of annular zones, nB1 represents a refractive index of the first lens at the first wavelength λ₁, nB2 represents a refractive index of the second lens at the first wavelength λ₁, nR1 represents a refractive index of the first lens at the second wavelength λ₂, nR2 represents a refractive index of the second lens at second wavelength λ₂, R represents a radius of curvature of the cementing surface of the chromatic aberration correction element, and f1 represents a total focal length at the first wavelength λ₁, nB3 represents a refractive index of the objective lens at the first wavelength λ₁, and nR3 represents the refractive index of the objective lens at second wavelength λ₂.

13. The objective optical system according to claim 12,
wherein the objective optical system satisfies a condition:
$$0.85 < \frac{\{ ( nB 1 - nB 2 ) - ( nR 1 - nR 2 ) \} \{ ( f 1 / R ) - 0.03 {P}_{12} \}}{nB 3 - nR 3} < 1.40 . \qquad ( 5 )$$

14. The objective optical system according to claim 12,
wherein the objective optical system satisfies a condition:
$$1.10 < \frac{\{ ( nB 1 - nB 2 ) - ( nR 1 - nR 2 ) \} \{ ( f 1 / R ) - 0.06 {P}_{12} \}}{nB 3 - nR 3} < 1.80 . \qquad ( 6 )$$

15. The objective optical system according to claim 11,
wherein the at least one diffracting surface is configured such that a diffraction order at which the diffraction efficiency for the first light beam is maximized is a third order, and
wherein the objective optical system satisfies a condition:
$$0.25 < \frac{\{ ( nB 1 - nB 2 ) - ( nR 1 - nR 2 ) \} \{ ( f 1 / R ) - 0.03 {P}_{12} \}}{nB 3 - nR 3} < 1.19 \qquad ( 14 )$$
where N represents the number of annular zones, nB1 represents a refractive index of the first lens at the first wavelength λ₁, nB2 represents a refractive index of the second lens at the first wavelength λ₂, nR1 represents a refractive index of the first lens at the second wavelength λ₂, nR2 represents a refractive index of the second lens at second wavelength λ₂, R represents a radius of curvature of the cementing surface of the chromatic aberration correction element, and f1 represents a total focal length at the first wavelength λ₁, nB3 represents a refractive index of the objective lens at the first wavelength λ₁, and nR3 represents the refractive index of the objective lens at second wavelength λ₂.

16. The objective optical system according to claim 15,
wherein the objective optical system satisfies a condition:
$$0.48 < \frac{\{ ( nB 1 - nB 2 ) - ( nR 1 - nR 2 ) \} \{ ( f 1 / R ) - 0.03 {P}_{12} \}}{nB 3 - nR 3} < 0.98 . \qquad ( 15 )$$

17. The objective optical system according to claim 15,
wherein the objective optical system satisfies a condition:
$$0.45 < \frac{\{ ( nB 1 - nB 2 ) - ( nR 1 - nR 2 ) \} \{ ( f 1 / R ) - 0.06 {P}_{12} \}}{nB 3 - nR 3} < 0.86 . \qquad ( 16 )$$

18. The objective optical system according to claim 11, further comprising an optical element on which the at least one diffracting surface is formed.

19. The objective optical system according to claim 11, wherein the at least one diffracting surface is formed on at least one of surfaces of the objective lens.

20. The objective optical system according to claim 11, wherein:
the first lens of the chromatic aberration correction element includes a planoconcave lens;
the second lens of the chromatic aberration correction element includes a planoconvex lens; and
the chromatic aberration correction element is configured such that curved surfaces of the first lens and the second lens form the cementing surface.

21. An optical information recording/reproducing device for recording information to and/or reproducing information from three types of optical discs including a first optical disc having a highest recording density, a second optical disc having a second highest recording density and a third optical disc having a lowest recording density, by selectively using one of three types of light beams including first, second and third light beams,
when wavelengths of the first to third light beams are respectively represented by λ₁ (nm), λ₂ (nm) and λ₃ (nm), λ₁<λ₂<λ₃ being satisfied,
when a thickness of a protective layer of the first optical disc requiring use of the first light beam is represented by t1 (mm), a thickness of a protective layer of the second optical disc requiring use of the second light beam is represented by t2 (mm), and a thickness of a protective layer of the third optical disc requiring use of the third light beam is represented by t3 (mm), t1≈0.6 (mm), t2≈0.6 (mm) and t3≈0.2 (mm) being satisfied,
when a numerical aperture necessary for recording information to or reproducing information from the first optical discs is represented by NA1, a numerical aperture necessary for recording information to or reproducing information from the second optical discs is represented by NA2, and a numerical aperture necessary for recording information to or reproducing information from the third optical discs is represented by NA3, a relationship NA1>NA3 and NA2>NA3 being satisfied,
the optical information recording/reproducing device comprising:
three light sources respectively emitting the first, second and third light beams; and
an objective optical system,
wherein the objective optical system comprises:
a chromatic aberration correction element including a first lens having a negative power and a second lens having a positive power, materials of the first lens and the second lens being different from each other, the first lens and the second lens being cemented together via a cementing surface to correct a longitudinal chromatic aberration;
at least one phase shift surface configured to have a plurality of annular refractive surface zones concentrically formed about a reference axis of the at least one phase shift surface and to have at least one type of step formed between adjacent ones of the plurality of annular refractive surface zones to give at least one type of predetermined optical path length difference to the first light beam; and
an objective lens,
wherein each of the chromatic aberration correction element and the at least one phase shift surface is located along an optical path common to the first and second light beams, and
wherein the chromatic aberration correction element is located on a light source side with respect to the objective lens.

22. The optical information recording/reproducing device according to claim 21, wherein:
the at least one type of predetermined optical path length difference given by the at least one phase shift surface to the first light beam is approximately equal to 2λ₁; and
the objective optical system satisfies a condition:
$$0.44 < \frac{\{ ( nB 1 - nB 2 ) - ( nR 1 - nR 2 ) \} \{ ( f 1 / R ) + 0.008 N \}}{nB 3 - nR 3} < 2.00 \qquad ( 1 )$$
where N represents the number of annular zones, nB1 represents a refractive index of the first lens at the first wavelength λ₁, nB2 represents a refractive index of the second lens at the first wavelength λ₁, nR1 represents a refractive index of the first lens at the second wavelength 2, nR2 represents a refractive index of the second lens at second wavelength λ2, R represents a radius of curvature of the cementing surface of the chromatic aberration correction element, and f1 represents a total focal length at the first wavelength λ₁, nB3 represents a refractive index of the objective lens at the first wavelength λ₁, and nR3 represents the refractive index of the objective lens at second wavelength λ₂.

23. The optical information recording/reproducing device according to claim 22,
wherein the objective optical system satisfies a condition:
$$0.74 < \frac{\{ ( nB 1 - nB 2 ) - ( nR 1 - nR 2 ) \} \{ ( f 1 / R ) + 0.008 N \}}{nB 3 - nR 3} < 1.70 . \qquad ( 2 )$$

24. The optical information recording/reproducing device according to claim 22,
wherein the objective optical system satisfies a condition:
$$0.95 < \frac{\{ ( nB 1 - nB 2 ) - ( nR 1 - nR 2 ) \} \{ ( f 1 / R ) + 0.014 N \}}{nB 3 - nR 3} < 2.19 . \qquad ( 3 )$$

25. The optical information recording/reproducing device according to claim 21, wherein:
the at least one type of predetermined optical path length difference given by the at least one phase shift surface to the first light beam is approximately equal to 3λ₁; and
the objective optical system satisfies a condition:
$$0.43 < \frac{\{ ( nB 1 - nB 2 ) - ( nR 1 - nR 2 ) \} \{ ( f 1 / R ) + 0.008 N \}}{nB 3 - nR 3} < 1.38 \qquad ( 11 )$$
where N represents the number of annular zones, nB1 represents a refractive index of the first lens at the first wavelength λ₁, nB2 represents a refractive index of the second lens at the first wavelength λ₁, nR1 represents a refractive index of the first lens at the second wavelength λ₂, nR2 represents a refractive index of the second lens at second wavelength λ₂, R represents a radius of curvature of the cementing surface of the chromatic aberration correction element, and f1 represents a total focal length at the first wavelength λ₁, nB3 represents a refractive index of the objective lens at the first wavelength λ₁, and nR3 represents the refractive index of the objective lens at second wavelength λ₂.

26. The optical information recording/reproducing device according to claim 25,
wherein the objective optical system satisfies a condition:
$$0.68 < \frac{\{ ( nB 1 - nB 2 ) - ( nR 1 - nR 2 ) \} \{ ( f 1 / R ) + 0.008 N \}}{nB 3 - nR 3} < 1.13 . \qquad ( 12 )$$

27. The optical information recording/reproducing device according to claim 25,
wherein the objective optical system satisfies a condition:
$$0.80 < \frac{\{ ( nB 1 - nB 2 ) - ( nR 1 - nR 2 ) \} \{ ( f 1 / R ) + 0.014 N \}}{nB 3 - nR 3} < 1.13 . \qquad ( 13 )$$

28. The optical information recording/reproducing device according to claim 21,
wherein the at least one type of predetermined optical path length difference given by the at least one phase shift surface to the first light beam is approximately equal to 2λ₁; and the optical information recording/reproducing device satisfies conditions:
−0.02<f1×M1<0.02 (7),
−0.02<f2×M2<0.02 (8), and
−0.28<f3×M3<−0.18 (9)
where M1 represents a total magnification of the objective optical system defined when the first optical disc is used, f2 represents a total focal length of the objective optical system at the second wavelength λ₂, and M2 represents a total magnification of the objective optical system defined when the second optical disc is used, f3 represents a total focal length of the objective optical at the third wavelength λ₃, and a M3 represents a total magnification of the objective optical system defined when the third optical disc is used.

29. The optical information recording/reproducing device according to claim 21,
wherein the at least one type of predetermined optical path length difference given by the at least one phase shift surface to the first light beam is approximately equal to 3λ₁; and the optical information recording/reproducing device satisfies conditions:
−0.02<f1×M1<0.02 (7),
−0.02<f2×M2<0.02 (8), and
−0.19<f3×M3<−0.05 (17)
where M1 represents a total magnification of the objective optical system defined when the first optical disc is used, f2 represents a total focal length of the objective optical system at the second wavelength λ₂, and M2 represents a total magnification of the objective optical system defined when the second optical disc is used, f3 represents a total focal length of the objective optical at the third wavelength λ₃, and a M3 represents a total magnification of the objective optical system defined when the third optical disc is used.

30. The optical information recording/reproducing device according to claim 21, wherein the chromatic aberration correction element satisfies a condition:
$$- 3.30 < \frac{nB 1 - nB 2}{nR 1 - nR 2} < - 0.30 \qquad ( 10 )$$
where nB1 represents a refractive index of the first lens at the first wavelength λ₁, nB2 represents a refractive index of the second lens at the first wavelength λ₁, nR1 represents a refractive index of the first lens at the second wavelength λ₂, and nR2 represents a refractive index of the second lens at second wavelength λ₂.

31. The optical information recording/reproducing device according to claim 21, wherein:
the at least one phase shift surface is configured to have two types of steps; and
each of the first, second and third light beams is incident on the objective optical system as a substantially collimated beam.

32. An optical information recording/reproducing device for recording information to and/or reproducing information from three types of optical discs including a first optical disc having a highest recording density, a second optical disc having a second highest recording density and a third optical disc having a lowest recording density, by selectively using one of three types of light beams including first, second and third light beams,
when wavelengths of the first to third light beams are respectively represented by λ₁ (nm), λ₂ (nm) and λ₃ (nm), λ₁<λ₂<λ₃ being satisfied,
when a thickness of a protective layer of the first optical disc requiring use of the first light beam is represented by t1 (mm), a thickness of a protective layer of the second optical disc requiring use of the second light beam is represented by t2 (mm), and a thickness of a protective layer of the third optical disc requiring use of the third light beam is represented by t3 (mm), t1≈0.6 (mm), t2≈0.6 (mm) and t3≈1.2 (mm) being satisfied,
when a numerical aperture necessary for recording information to or reproducing information from the first optical discs is represented by NA1, a numerical aperture necessary for recording information to or reproducing information from the second optical discs is represented by NA2, and a numerical aperture necessary for recording information to or reproducing information from the third optical discs is represented by NA3, a relationship NA1>NA3 and NA2>NA3 being satisfied,
the optical information recording/reproducing device comprising:
three light sources respectively emitting the first, second and third light beams; and
an objective optical system,
wherein the objective optical system comprises:
a chromatic aberration correction element including a first lens having a negative power and a second lens having a positive power, materials of the first lens and the second lens being different from each other, the first lens and the second lens being cemented together via a cementing surface to correct a longitudinal chromatic aberration;
at least one diffracting surface; and
an objective lens,
wherein:
the at least one diffracting surface is represented by at least one optical path length difference function φi(h) (where i is an integer):
φ(h)=(Pᵢ₂h²+Pᵢ₄h⁴+Pᵢ₆h⁶+Pᵢ₈h⁸+Pᵢ₁₀h¹⁰+Pᵢ₁₂h¹²)mᵢλ
where Pᵢ₂, Pᵢ₄, Pᵢ₆ represents 2-th, 4-th, 6-th . . . coefficients, mᵢ represents a diffraction order at which diffraction efficiency of an incident light beam incident on the at least one diffracting surface is maximized, and X represents a design wavelength of the incident light beam;
each of the chromatic aberration correction element and the at least one diffracting surface is located along an optical path common to the first and second light beams; and
the chromatic aberration correction element is located on a light source side with respect to the objective lens.

33. The optical information recording/reproducing device according to claim 32,
wherein the at least one diffracting surface is configured such that a diffraction order at which the diffraction efficiency for the first light beam is maximized is a second order, and
wherein the objective optical system satisfies a condition:
$$0.55 < \frac{\{ ( nB 1 - nB 2 ) - ( nR 1 - nR 2 ) \} \{ ( f 1 / R ) - 0.03 {P}_{12} \}}{nB 3 - nR 3} < 1.65 \qquad ( 4 )$$
where N represents the number of annular zones, nB1 represents a refractive index of the first lens at the first wavelength λ₁, nB2 represents a refractive index of the second lens at the first wavelength λ₁, nR1 represents a refractive index of the first lens at the second wavelength λ₂, nR2 represents a refractive index of the second lens at second wavelength λ₂, R represents a radius of curvature of the cementing surface of the chromatic aberration correction element, and f1 represents a total focal length at the first wavelength λ₁, nB3 represents a refractive index of the objective lens at the first wavelength λ₁, and nR3 represents the refractive index of the objective lens at second wavelength λ₂.

34. The optical information recording/reproducing device according to claim 33,
wherein the objective optical system satisfies a condition:
$$0.85 < \frac{\{ ( nB 1 - nB 2 ) - ( nR 1 - nR 2 ) \} \{ ( f 1 / R ) - 0.03 {P}_{12} \}}{nB 3 - nR 3} < 1.40 . \qquad ( 5 )$$

35. The optical information recording/reproducing device according to claim 33,
wherein the objective optical system satisfies a condition:
$$1.10 < \frac{\{ ( nB 1 - nB 2 ) - ( nR 1 - nR 2 ) \} \{ ( f 1 / R ) - 0.06 {P}_{12} \}}{nB 3 - nR 3} < 1.80 . \qquad ( 6 )$$

36. The optical information recording/reproducing device according to claim 32,
wherein the at least one diffracting surface is configured such that a diffraction order at which the diffraction efficiency for the first light beam is maximized is a third order, and
wherein the objective optical system satisfies a condition:
$$0.25 < \frac{\{ ( nB 1 - nB 2 ) - ( nR 1 - nR 2 ) \} \{ ( f 1 / R ) - 0.03 {P}_{12} \}}{nB 3 - nR 3} < 1.19 \qquad ( 14 )$$
where N represents the number of annular zones, nB1 represents a refractive index of the first lens at the first wavelength λ₁, nB2 represents a refractive index of the second lens at the first wavelength λ₁, nR1 represents a refractive index of the first lens at the second wavelength λ₂, nR2 represents a refractive index of the second lens at second wavelength λ₂, R represents a radius of curvature of the cementing surface of the chromatic aberration correction element, and f1 represents a total focal length at the first wavelength λ₁, nB3 represents a refractive index of the objective lens at the first wavelength λ₁, and nR3 represents the refractive index of the objective lens at second wavelength λ₂.

37. The optical information recording/reproducing device according to claim 36,
wherein the objective optical system satisfies a condition:
$$0.48 < \frac{\{ ( nB 1 - nB 2 ) - ( nR 1 - nR 2 ) \} \{ ( f 1 / R ) - 0.03 {P}_{12} \}}{nB 3 - nR 3} < 0.98 . \qquad ( 15 )$$

38. The optical information recording/reproducing device according to claim 36,
wherein the objective optical system satisfies a condition:
$$0.45 < \frac{\{ ( nB 1 - nB 2 ) - ( nR 1 - nR 2 ) \} \{ ( f 1 / R ) - 0.06 {P}_{12} \}}{nB 3 - nR 3} < 0.86 . \qquad ( 16 )$$

39. The optical information recording/reproducing device according to claim 32,
wherein the at least one diffracting surface is configured such that a diffraction order at which the diffraction efficiency for the first light beam is maximized is a second order, and
wherein the optical information recording/reproducing device satisfies conditions:
−0.02<f1×M1<0.02 (7),
−0.02<f2×M2<0.02 (8), and
−0.28<f3×M3<−0.18 (9)
where M1 represents a total magnification of the objective optical system defined when the first optical disc is used, f2 represents a total focal length of the objective optical system at the second wavelength λ₂, and M2 represents a total magnification of the objective optical system defined when the second optical disc is used, f3 represents a total focal length of the objective optical system at the third wavelength λ₃ and a M3 represents a total magnification of the objective optical system defined when the third optical disc is used.

40. The optical information recording/reproducing device according to claim 32,
wherein the at least one diffracting surface is configured such that a diffraction order at which the diffraction efficiency for the first light beam is maximized is a third order, and
wherein the optical information recording/reproducing device satisfies conditions:
−0.02<f1×M1<0.02 (7),
−0.02<f2×M2<0.02 (8), and
−0.19<f3×M3<−0.05 (17)
where M1 represents a total magnification of the objective optical system defined when the first optical disc is used, f2 represents a total focal length of the objective optical system at the second wavelength λ₂, and M2 represents a total magnification of the objective optical system defined when the second optical disc is used, f3 represents a total focal length of the objective optical system at the third wavelength λ₃, and a M3 represents a total magnification of the objective optical system defined when the third optical disc is used.

41. The optical information recording/reproducing device according to claim 32, wherein the chromatic aberration correction element satisfies a condition:
$$- 3.30 < \frac{nB 1 - nB 2}{nR 1 - nR 2} < - 0.30 \qquad ( 10 )$$
where nB1 represents a refractive index of the first lens at the first wavelength λ₁, nB2 represents a refractive index of the second lens at the first wavelength λ₁, nR1 represents a refractive index of the first lens at the second wavelength λ₂, and nR2 represents a refractive index of the second lens at second wavelength λ₂.

42. The optical information recording/reproducing device according to claim 32,
wherein:
the at least one diffracting surface is represented by two optical path length difference functions; and
each of the first, second and third light beams is incident on the objective optical system as a collimated beam.
